(19) United States
(12) Patent Application Publication
(10) Pub. No.: US 2014/0164288 A1
(43) Pub. Date: Jun. 12, 2014

(54) SYSTEMS FOR DETERMINING AND PROVIDING A PORTFOLIO OVERLAY FOR INVESTMENT PORTFOLIO ADJUSTMENT TO MITIGATE FINANCIAL RISK

(71) Applicant: F-Squared Investments, Inc., Newton, MA (US)

(72) Inventors: Howard Present, Newton, MA (US); Vadim Fishman, Beach Haven, NJ (US)

(73) Assignee: F-Squared Investments, Inc., Newton, MA (US)

(21) Appl. No.: 14/051,361

(22) Filed: Oct. 10, 2013

Related U.S. Application Data
(60) Provisional application No. 61/712,094, filed on Oct. 10, 2012.
(60) Provisional application No. 61/829,209, filed on May 30, 2013.
(60) Provisional application No. 61/841,312, filed on Jun. 29, 2013.

(51) Int. Cl. G06Q 40/06

(52) U.S. Cl. CPC G06Q 40/06
USPC 705/36 R

(57) ABSTRACT

The disclosed technology, in certain embodiments, analyzes financial market data to determine a financial overlay that is provided to portfolio owners in order to notify or alert the portfolio owner regarding when to convert an investment to cash and/or cash equivalents, buy an investment, or sell an investment. In certain embodiments, financial market data is used to determine the status of respective market sectors based on a change in behavior and/or a correlation to a financial index. In certain embodiments, a financial overlay decision associated with the market sectors is determined based on the status of a market sector. The financial overlay decision may be provided to portfolio owners and may include a decision to maintain an investment, buy an investment, sell an investment, or convert an investment to cash or cash equivalents.

### RELATED APPLICATIONS

The present application claims priority to U.S. provisional application Ser. No. 61/712,094, filed Oct. 10, 2012, U.S. provisional application Ser. No. 61/829,209, filed May 30, 2013, and U.S. provisional application Ser. No. 61/841,312, filed Jun. 29, 2013, the entire contents of which are incorporated by reference.

### BACKGROUND

Traditional investment management focuses on the individual investor's adversity to risk when determining how to manage the individual's investments. Certain investors will not tolerate large and/or frequent fluctuations associated with riskier investments and therefore investment managers often select investments that are appropriate for an inventor's adversity to risk.

Typically, traditional investment management defines risk based on the amount of funds an individual can tolerate losing in a short period of time, the worst decline an individual could face, and whether the individual can handle daily volatility. The traditional strategies may select a benchmark based on the individual investor's adversity to risk and select an investment portfolio, such as an exchange traded fund, with the goal of tracking the benchmark. However, the portfolio will track the benchmark during both upswings and downswings of the market.

For example, if the benchmark, such as the S&P 500, decreases by 20% in a given year, the investment portfolio tied to that benchmark will fall roughly 20%. A benchmark investment strategy may be considered successful if the benchmark falls by 20% while the benchmarked investment portfolio only falls by 16%. Thus, this strategy does not eliminate an investor's exposure to market downswings. Investors still need protection from severe losses in down markets while also participating in rising markets. Thus, there is a need for an approach that results in significantly reduced overall downside risk and highly asymmetrical investment returns from rising markets. Particularly, there is a need for strategies, particularly for use in negative market environments, that have minimal correlation to traditional indices and asset classes.

The impact of a sharp market decline can be devastating to an investor's savings plan. While it is not possible to forecast market loss for a particular investment, it has been seen that a product's historical decline from its peak performance point to its lowest performance point is a strong indicator of the inherent risk of loss for that investment during a market downturn. This risk measurement is known as “Maximum Drawdown” (Max DD). An investment strategy should reduce exposure in negative periods and benefit from participation in positive markets. However, it has been noted that market “extreme downs” are more frequent and have greater impact on overall portfolio value than “extreme ups.” There remains a need for systems and methods for determining and administering a trading strategy that more effectively reduces exposure of a portfolio to risk, while still allowing the portfolio to benefit sufficiently from market gains.

An investor may have a portfolio manager oversee the investor's investment portfolio. The portfolio manager typically collects fees in exchange for this service. Often the fee is a percentage of the profits or a percentage of the money managed and may be quite expensive. Thus, there is a need for reducing an individual's exposure to market downswings at a more affordable cost.

Some investors have multiple portfolios which may be managed by different managers. Decisions an individual manager makes with regard to one of the investor's portfolios may impact the risk of the overall portfolio, have negative tax effects, or unbalance investment positions. Overlay management systems may be used to track an investor's overall portfolio from the separate management accounts. The overlay system may track the portfolio to ensure it remains in balance and maintains a level of risk appropriate for the investor. Accordingly, overlay management systems are tailored to an individual investor's needs and focus on data specific to the investor being tracked instead of generic financial market data. Typically, the analysis is performed on an individual basis, which contributes to the cost of managing an investment portfolio. Thus, there is a need for a system to distribute generic advice based on market sector trends in financial market data, where the generic advice can be applied to individual investment portfolios to mitigate risk associated with the portfolio.

### SUMMARY

Described herein are methods and systems for determining and providing a financial overlay based on financial market data for various sectors to a portfolio owner for use in adjusting the owner's financial portfolio. Also described herein are methods and systems for determining a trading strategy by making a probabilistic projection of expected returns for various financial investments in an owner's financial portfolio.

The disclosed technology, in certain embodiments, analyzes financial market data to determine a financial overlay that is provided to portfolio owners in order to notify or alert the portfolio owner regarding when to convert an investment to cash and/or cash equivalents, buy an investment, or sell an investment. In certain embodiments, financial market data pertaining to investments is used to identify a respective market sector associated with each investment in the market data. Each market sector may be analyzed to determine the status of the respective market sector based on a change in behavior and/or a correlation to a financial index. Financial models may be used to determine which market sectors of the underlying portfolio are active and/or expected to have a positive performance over a time period.

An important feature of the disclosed technology, in certain embodiments, is the determination of a financial overlay decision associated with the market sectors. The overlay decision may be based on the status of the market sector and may be a decision to maintain an investment, buy an investment, sell an investment, or convert an investment to cash or cash equivalents.

Another important feature of the disclosed technology, in certain embodiments, is providing the financial overlay decision for use as a financial overlay to a financial portfolio. The financial overlay decision may be at least part of a loss protection strategy to be applied to the financial portfolio to reduce a market exposure of the financial portfolio. The financial portfolio may include investments from the market sector and the financial overlay may be applied to the financial portfolio in order to adjust the holdings of the financial portfolio in a particular market sector. Based on a recommendation to convert investments in a specific sector to cash or cash equivalents based on a prediction that the sector is going to decline in the near future, the financial overlay may be tailored to apply such a conversion to the financial portfolio of a portfolio owner.

Another important feature of the disclosed technology, in certain embodiments, is the receipt of the overlay decision by the portfolio owner as part of a subscription service. The portfolio owner may pay the provider of the subscription service in exchange for the subscription.

In one aspect, the disclosed technology is directed to a method including the steps of: (a) receiving, via a network, by a first entity, financial data regarding a plurality of investments; (b) identifying, by a processor of a computing device, a respective market sector associated with each investment of the plurality of investments; (c) analyzing, by the processor, for each market sector of a plurality of market sectors, one or more investments of the plurality of investments to determine a status of the respective market sector, wherein each investment of the one or more investments is associated with the respective market sector, and the status is based at least in part on one or more of i) a change in behavior, and ii) a correlation to a financial index; (d) determining, by the processor, based in part upon the status, a decision associated with a first market sector of the plurality of market sectors; and (e) providing, to a second entity, the decision for use as a financial overlay to a financial portfolio, wherein the financial portfolio comprises the first market sector.

In certain embodiments, a first financial portfolio includes the plurality of market sectors, and the financial portfolio includes at least a portion of the plurality of market sectors.

In certain embodiments, the second entity is an external managing entity and the external managing entity applies the decision to at least a portion of the financial portfolio of a third entity; and the external managing entity and the third entity are independent of the first entity. In certain embodiments, the second entity is the same entity as the first entity.

In another aspect, the disclosed technology is directed to a system for determining a trading strategy that makes intelligent decisions on whether to retain or remove a financial index from a market portfolio, the system comprising a processor and a memory storing a set of instructions that, when executed by the processor, cause the processor to: measure the current closing price of a financial index for a plurality of days; calculate a closing price trend of the financial index by using the current closing price of the plurality of days; calculate a true range market volatility measure for each day of the plurality of days; suppress undesired noise in the market volatility measure by computing a HAAR based average of the true range market volatility measure of the plurality of days; calculate a CUSUM statistic by performing a cumulative sum based algorithm for disorder detection using the noise suppressed market volatility measure, current closing price of the financial index for a particular day, and the calculated closing price trend; determine whether the current closing price for the particular day is bigger than (e.g., substantially bigger with respect to volatility values) or smaller than (e.g., substantially smaller with respect to volatility values) the closing price trend by applying the CUSUM statistic, whereupon one of (i) or (ii) is performed: (i) upon determining that the current closing price is bigger than the closing price trend, retain the financial index in the market portfolio (e.g., and restart computation of the CUSUM statistic, e.g., set the CUSUM statistic to zero); and (ii) upon determining that the current closing price is smaller than the closing price trend, maintain the CUSUM statistic for subsequent CUSUM calculations and remove the financial index from the market portfolio in the future.

In some embodiments, the financial index refers to a sector, a set of ETFs, an ETF, a fund, a fund of funds, a set of funds, a security (e.g., bond, stock, etc.), a set of securities, or the like. In some embodiments, the instructions cause the processor to calculate the true range market volatility by: calculating smooth coefficients and detail coefficients of a direct HAAR transform from the current closing price of the financial index for the plurality of days; determining HAAR coefficients from the smooth coefficients and the detail coefficients; performing hard and/or soft thresholding of the detail coefficients using the HAAR coefficients; and calculating an inverse HAAR transform from the smooth coefficients and the thresholded detail coefficients. In some embodiments, the instructions cause the processor to: iteratively update the true range market volatility measure; and iteratively update the CUSUM statistic using current market data. In some embodiments, the instructions cause the processor to determine whether the current closing price for the particular day is significantly bigger or significantly smaller than the closing price trend by performing one or both of the following: (i) determining whether the current closing price for the particular day is significantly higher than the closing price trend by comparing the CUSUM statistic against a predetermined maximum threshold stored in the memory; and (ii) determining whether the current closing price for the particular day is significantly lower than the closing price trend by comparing the CUSUM statistic against a predetermined minimum threshold stored in the memory. In some embodiments, the CUSUM statistic is calculated to reduce risk of severe loss to the market portfolio in volatile market conditions.

In another aspect, the disclosed technology is directed to a method for determining a trading strategy that makes intelligent decisions on whether to retain or remove a financial index from a market portfolio, the method comprising: measuring, by a processor of a computing device, the current closing price of a financial index for a plurality of days; calculating, by the processor, a closing price trend of the financial index by using the current closing price of the plurality of days; calculating, by the processor, a true range market volatility measure for each day of the plurality of days; suppressing, by the processor, undesired noise in the market volatility measure by computing a HAAR based average of the true range market volatility measure of the plurality of days; calculating, by the processor, a CUSUM statistic by performing a cumulative sum based algorithm for disorder detection using the noise suppressed market volatility measure, current closing price of the financial index for a particular day, and the calculated closing price trend; determining whether the current closing price for the particular day is bigger than (e.g., substantially bigger with respect to volatility values) or smaller than (e.g., substantially smaller with respect to volatility values) the closing price trend by applying the CUSUM statistic, whereupon one of (i) or (ii) is performed: (i) upon determining that the current closing price is bigger than the closing price trend, retaining the financial index in the market portfolio (e.g., and restart computation of the CUSUM statistic, e.g., set the CUSUM statistic to zero); and (ii) upon determining that the current closing price is smaller than the closing price trend, maintaining the CUSUM statistic for subsequent CUSUM calculations and removing the financial index from the market portfolio in the future.

In some embodiments, the calculation of the true range market volatility further comprises: calculating, by the processor, smooth coefficients and detail coefficients of a direct HAAR transform from the current closing price of the financial index for the plurality of days; determining, by the processor, HAAR coefficients from the smooth coefficients and the detail coefficients; performing hard and/or soft thresholding, by the processor, of the detail coefficients using the HAAR coefficients; and calculating, by the processor, an inverse HAAR transform from the smooth coefficients and the thresholded detail coefficients. In some embodiments, the method further comprises iteratively updating, by the processor, the true range market volatility measure; and iteratively updating, by the processor, the CUSUM statistic using current market data. In some embodiments, determining whether the current closing price for the particular day is significantly bigger or significantly smaller than the closing price trend further comprises: determining, by the processor, that the current closing price for the particular day is significantly higher than the closing price trend by comparing the CUSUM statistic against a predetermined maximum threshold stored in a memory of the computing device; and determining, by the processor, that the current closing price for the particular day is significantly lower than the closing price trend by comparing the CUSUM statistic against a predetermined minimum threshold stored in the memory. In some embodiments, the CUSUM statistic is calculated to reduce risk of severe loss to the market portfolio in volatile market conditions.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIGS. 1A and 1B are diagrams of example systems for determining and providing a financial overlay based on financial market data for various sectors to a portfolio owner for use in adjusting the owner's financial portfolio;

FIG. 2 is flow chart illustrating a method for calculating an investment strategy by making a probabilistic projection of expected returns for various financial instruments in an owner's financial portfolio;

FIGS. 3A and 3B are flow charts describing an example method for determining and providing a financial overlay for investment portfolio adjustment to mitigate financial risk;

FIG. 4 is a flow chart of an example method for providing a financial overlay decision to a portfolio owner for investment portfolio adjustment to mitigate financial risk;

FIG. 5 is a flow chart of an example method for determining and providing a financial overlay decision for investment portfolio adjustment to mitigate financial risk;

FIGS. 6A and 6B illustrate a flow chart of an example method for estimating volatility and future closing price of a financial index;

FIGS. 7A and 7B illustrate a flow chart of an example method for applying CUSUM statistics to detect shifts in the price of a financial index;

FIGS. 8A and 8B illustrate a flow chart of an example method for making decisions regarding investment portfolio adjustments based upon volatility measurements and statistics on price shifts;

FIG. 9 is a block diagram of an exemplary cloud computing environment, in accordance with an illustrative embodiment of the disclosed technology; and

FIG. 10 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, material disclosed in the background section shall not be construed as an admission of prior art.

### DETAILED DESCRIPTION

In some embodiments, a financial portfolio owner wants to mitigate financial risk caused by price variations in the market. In particular, financial portfolio owners want to minimize exposure to financial market downturns. Portfolio owners may use a financial overlay to minimize the loss associated with market fluctuations. A financial overlay may provide portfolio owners with guidance on how the financial portfolio should be allocated among investments in order to mitigate financial risk. As explained below, financial overlays may identify specific market sectors and/or investments that should be bought, sold, or transferred to cash equivalents. The financial overlay may be provided to financial portfolio owners who may then implement the financial overlay. Thus, the cost of providing financial overlays to financial portfolio owners is reduced because the provider of the financial overlay does not necessarily manage the portfolio itself.

The financial overlay may instruct the owner of the financial portfolio to sell specific securities or securities in a specific sector and invest the proceeds in cash or cash equivalents to avoid losses associated with anticipated devaluation in that security or market sector. For example, an entity may have an investment portfolio including stock in a publicly traded company. If the entity participates in the subscription service, the entity may receive a financial overlay via email from the provider of the service every week. The financial overlay may tell the entity what portion of the investment portfolio should be in stock based on the market sector to which the stock belongs. The entity will continue receiving these emails every week. After a few weeks, the financial overlay may change and suggest that the portfolio include 20% in cash. At this point the entity may sell 20% of the stock and invest it in cash. After a couple of weeks, the financial overlay may change again and suggest that the portfolio doesn't need to hold any cash. At this point the entity may use the cash to purchase more stock in the publicly traded company. After making the purchase, the company will once again have 100% of its portfolio invested in the publicly traded company. Additionally, the company's stock may have a higher cash value than it would have had if it had not switched to cash to avoid a potential downturn in the value of the company.

Systems and methods are presented herein that determine and/or administer a trading strategy by making a probabilistic projection of expected returns for various investment indexes (where an index, as used herein, can refer to a sector, a set of ETFs, an ETF, a fund, a fund of funds, a set of funds, a security (e.g., bond, stock, etc.), a set of securities, or the like). For example, expected returns for each of a set of market sectors (e.g., each of the nine major S&P 500 Sector ETFs) are determined. If any of the sectors (or indexes) are expected to lose money, they are removed from the portfolio (e.g., by conversion to cash or cash equivalents). Investment in the remaining sectors are then rebalanced. The goal is to avoid potential losses in the negative sectors while benefiting from the expected positive returns in the remaining sectors.

The systems and methods presented herein may evaluate the portfolio on an ongoing basis, e.g., on a regular basis (e.g., quarterly, monthly, weekly, or daily basis) and “derisk” the portfolio by removing toxic sectors from the portfolio as market conditions warrant. The index will then “re-risk” the portfolio by moving back into those sectors as market conditions improve.

More specifically, it has been found that utilizing a cumulative sum algorithm for disorder detection (CUSUM) of current closing price in determining whether to remove an index from a portfolio provides improved results. Furthermore, it has been found that utilizing a HAAR-based measure of volatility in the procedure provides improved results. The combination of the CUSUM approach with a HAAR-based measure of volatility provides further synergistic benefits. In certain embodiments, CUSUM is a sequential analysis technique that is used to monitor change detection. Samples from a process xₙ are assigned weights wₙ and summed such that S₀=0; and Sₙ₊₁=max(0, Sₙ+xₙ−wₙ). When the value of S exceeds a certain threshold value, a change in the value of S is found. Such a formula detects changes in the positive direction. In the event that negative changes need to be found, the minimum operation is used instead of the maximum operation, and consequently a change can be found when the value of S is below the negative value of the threshold value.

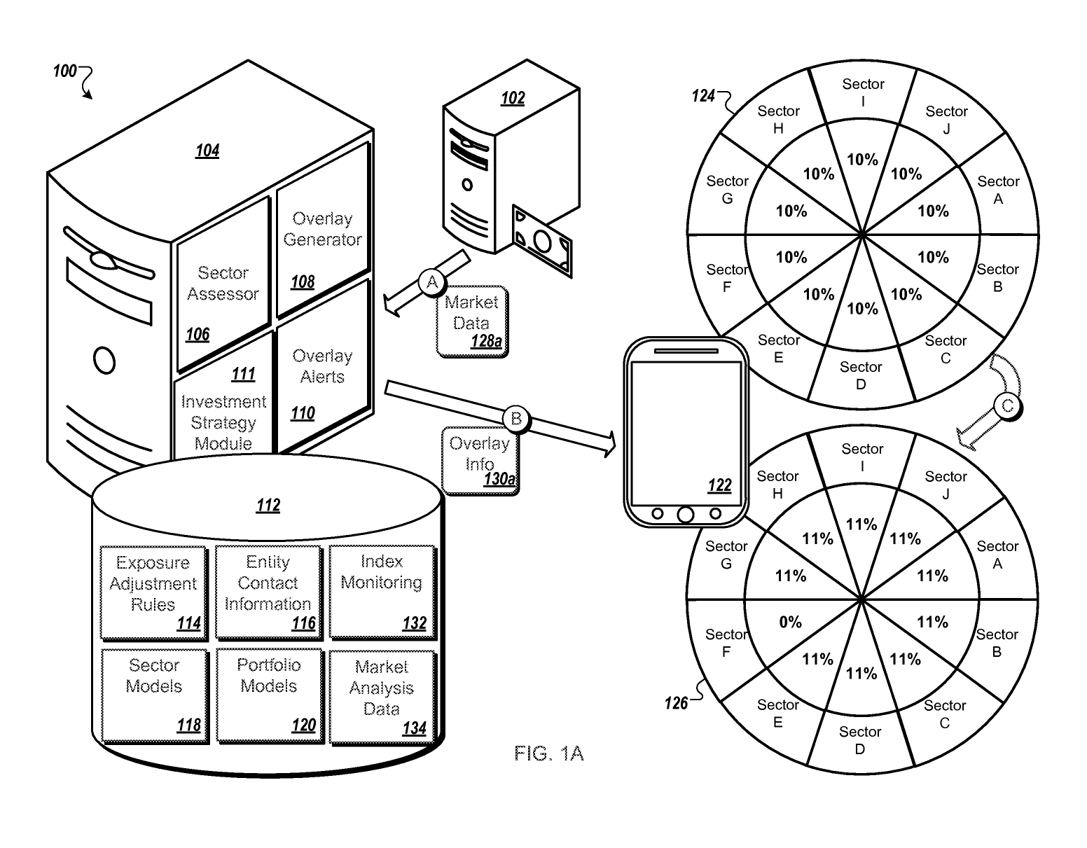

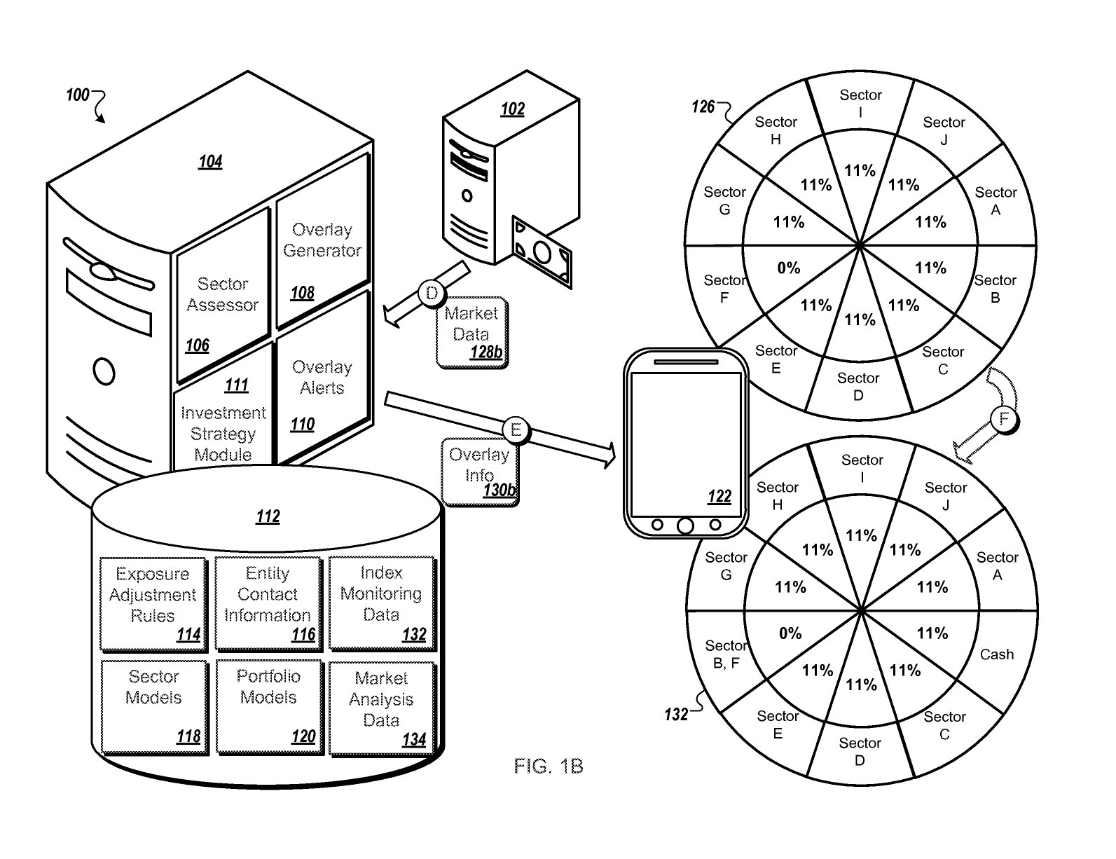

FIGS. 1A and 1B illustrate an example of a system 100 for determining and providing a financial overlay based on financial market data for various sectors to a portfolio owner for use in adjusting the owner's financial portfolio.

In some embodiments, the portfolio owner is a manager of the financial portfolio and/or the lawful owner of the financial portfolio or a portion of the financial portfolio. In some embodiments, the portfolio owner does not have direct responsibility for the management of the financial portfolio.

In some embodiments, the financial portfolio is a separately managed account, an institutional portfolio, a pension plan, a defined contribution plan, a trust fund, a collective trust fund, an index, a mono portfolio, derivative financial instruments, a total return swap, a mutual fund, an Investment Company Act of 1940 mutual fund, exchange-traded funds, and/or a packaged vehicle for investments.

In some embodiments, system 100 includes financial market data 128 stored on a financial market computer system 102. The market data 128 includes data from a variety of investments. The market data 128 may include current valuations, past valuations, data about the investments, forecasts, and/or data relating to market sectors.

In some embodiments, the market data 128 is transferred to an overlay computer system 104. The market data 128 may be automatically provided to the financial overlay computer system 104 or supplied after the financial overlay computer system 104 sends a request. The financial overlay computer system 104 may include a sector assessor 106, overlay generator 108, overlay alerts 110, investment strategy module 111, and a database 112. The database 112 may store exposure adjustment rules 114, entity contact information 116, sector models 118, and portfolio models 120, index monitoring data 132, and market analysis data 134.

After receiving the market data 128 from the financial market computer system, the financial overlay computer system 104 may use the sector assessor 106 to analyze and determine the sectors of each investment in the market data 128. The sector assessor 106 may determine to which sector each investment belongs and apply a tag to that investment so the system knows it is associated with a specific sector. The sector assessor 106 may use the sector models 118 stored in database 112 to perform this analysis. The sector models may include one or more sectors of the U.S. economy equity markets, one or more indexed equity categories associated with the Standard & Poor 500 index, one or more sectors of fixed income markets, one or more custom sectors combining equities and fixed income, sectors of emerging markets, one or more sectors of commodities, one or more sectors of asset classes uncorrelated to traditional markets, and/or one or more individual stocks in one or more individual companies.

The indexed equity categories may include the categories of basic materials, conglomerates, consumer goods, financial, healthcare, industrial goods, services, technology, and/or utilities. The fixed income markets may include AAA rated corporate bonds, mortgage backed securities, floating rate notes, investment grade bonds, government bonds, 7-10 year treasuries, emerging market bonds, convertible bonds, and/or high yield bonds. The sectors of the emerging markets may include emerging market exchange traded funds such as iShares MSCI Emerging Markets Index, Vanguard MSCI Emerging Markets ETF or one or more sectors of the U.S. economy correlated with one or more emerging market exchange traded funds.

In some embodiments, the overlay generator 108 of the financial overlay computer system 104 generates a financial overlay according to the sector of each investment. The financial overlay may suggest investments in a specific sector be increased, decreased, held steady, or transferred to cash and/or cash equivalents.

In some embodiments, the financial overlay includes a percentage of the financial portfolio to be in at least one of cash and cash equivalent financial instruments, a proportion of the financial portfolio to be in at least one of cash and cash equivalent financial instruments, and/or an amount of the financial portfolio to be in at least one of cash and cash equivalent financial instruments.

In some embodiments, the financial overlay includes percentages of the financial portfolio to be in one or more different categories, proportions of the financial portfolio to be in the one or more different categories, amounts of the financial portfolio to be in the one or more different categories, and/or weights of the financial portfolio to be in the one or more different categories. The different categories may be categories including of equities, bonds, and/or cash or cash equivalent instruments.

In some embodiments, the financial overlay includes information regarding which market sectors are included in the underlying market portfolio, which market sectors are not included in the underlying market portfolio, any market sector added to the underlying market portfolio, any market sector removed from the underlying market portfolio, which market sectors are expected to perform negatively based on the model, and/or which market sectors are expected to perform positively based on the model.

In some embodiments, the financial overlay identifies specific securities to include in the financial portfolio. In some embodiments, the financial overlay includes a recommended market reduction percentage for the financial portfolio. In some embodiments, the financial overlay includes advice regarding whether or not to move a portion of the financial portfolio to cash and/or portfolio construction advice relating to the financial portfolio.

In some embodiments, the financial overlay is based at least in part on a trigger event. In some embodiments, the financial overlay is based at least in part on an investment strategy, such as an investment strategy with an established track record.

The financial overlay may be used by portfolio owners to determine when to adjust their portfolios. In some embodiments, the financial overlay generator 108 uses portfolio models 120 stored in the database 112 to generate the financial overlay. In some embodiments, portfolio models 120 include a generic model, an aggressive model, moderate model, adverse model, individual models, or models based on sectors. The generic model, for example, may include all or a portion of the sectors represented in the financial market data. The aggressive, moderate, and adverse models, for example, may be tailored based on risk adversity. These models could be supplied to clients based on the client's risk adversity. These models do not rely on knowledge of individual client investment portfolios, however, in some embodiments, individual models may be custom tailored to a client's investment portfolio.

In some embodiments, an investment strategy module 111 determines an investment strategy. Financial decisions necessary to generate the financial overlay for an underlying market portfolio are based according to such an investment strategy. The investment strategy used to determine the financial overlay may be based on market data 128 received from financial market computer system 102 at financial overlay computer system 104. The market data 128 includes data from a variety of investments. The market data 128 used to make such decisions may include current valuations, past valuations, data about the investments, forecasts, and/or data relating to market sectors. In some embodiments, the investment strategy module 111 may determine how profitable a current sector is based on market data 128. For example, the investment strategy module 111 may monitor a financial index over time to determine the level of profit or loss, and the level of risk that a particular financial sector poses.

In some embodiments, an investment strategy module 111 determines an investment strategy by determining a probability of the risk of loss for each sector based asset (i.e., financial investment, financial instrument). In some embodiments, the investment strategy module 111 may take historical price returns of the sector's assets from market data 128 as an input in order to compute an investment strategy. In some embodiments, investment strategy module 111 may calculate a volatility measure for the sector's assets from the market data 128 and may consider that calculated value as an input in determining the investment strategy. An exemplary investment strategy may output as a result of the investment strategy, a determination of forecasted performance for each sector based asset with respect to cash returns. Overlay generator 104 may be able to use such forecasted performance to determine whether to remove or retain each sector from the financial portfolio.

In some embodiments, the financial overlay is determined for an underlying market portfolio. The underlying market portfolio may represent the entire market, a portion of the market, all sectors, or a portion of the sectors. In some embodiments, after determining the financial overlay for the underlying market portfolio, the financial overlay may be modified according to the exposure adjustment rules 114 stored in the database 112.

In some embodiments exposure adjustment rules 114 are used to customize a financial overlay. A subset of portfolio owners may be associated with a particular exposure adjustment rule. In some embodiments, the portfolio owner may receive tailored overlay decisions based on his/her exposure adjustment rules for free or for an additional fee.

In some embodiments, if the portfolio owner is associated with an exposure adjustment rule, the exposure adjustment rule is applied to the financial overlay decision. In some embodiments, the exposure adjustment rule may include modifying the financial overlay decision based on the financial portfolio of the portfolio owner and/or preferences of the portfolio owner.

In some embodiments, the preferences of the portfolio owner include a request to include market sectors of interest to the portfolio owner in the underlying market portfolio, a request to exclude identified market sectors from the underlying market portfolio, a request that the underlying market portfolio be constructed such that a measure of correlation between the underlying market portfolio and an equity based index exceeds a threshold, a request that the financial portfolio overlay be determined such that application of the financial portfolio overlay to the financial portfolio would not cause a measure of correlation between the financial portfolio and an equity based index to drop below a threshold, regulatory constraints associated with the financial portfolio, contractual constraints associated with the financial portfolio, a maximum limit of a proportion of the financial portfolio in cash equivalent financial instruments requirements imposed by the portfolio owner, and/or investment guidelines/requirements associated with the financial portfolio.

After generating the financial overlay, the financial overlay computer system 104 may generate overlay alerts 110. The financial overlay alert may contain overlay information 130 that is sent to a computer system 122 of the portfolio owner for display on the display screen. The overlay alerts 110 may include notifications sent to portfolio owners. The notifications may include the financial overlay or may notify the owners that a new financial overlay is available. In some embodiments, the various parties are in communication via a network. Data may be transmitted via the network.

The entity contact information 116 stored in database 112 may be used to contact the portfolio owner. The entity contact information 116 may be used for sharing the financial overlay decision with the portfolio owner. In some embodiments, the financial overlay decision is provided to the portfolio owner in an electronic format. The electronic format may be an email message, a text message, a social media post, an instant message, an electronic signal, a computer-readable signal, an audible message, a visual message, a calendar message, a task reminder, an alarm, and a mobile device function. In some embodiments, the financial overlay decision is provided to the portfolio owner via electronic media, wireless media, and/or a network.

In some embodiments, the portfolio owner uses the financial overlay to adjust the holdings of his/her financial portfolio. In some embodiments, the financial overlay is applied with respect to the entire portfolio. In some embodiments, the financial overlay is applied with respect to a portion of the portfolio. For example, a financial portfolio 124 of the portfolio owner may include U.S. equities invested evenly in sectors A through J. Accordingly, 10% of the financial portfolio 124 is invested in each of sectors A through J. The financial overlay generator may evaluate each sector based on market financial data 128 received from the financial market computer system 102.

The financial overlay generator, in particular the investment strategy module 111, may conclude that sector F is going to lose money going forward and the financial overlay generator may generate an overlay decision to sell that sector. After generating the financial overlay decision, the financial overlay computer system 104 may apply exposure adjustment rules 114 to the financial overlay decision. As explained above, exposure adjustment rules 114 may be associated with a particular portfolio or portfolio owner. The exposure adjustment rules 114 may be applied to the financial overlay decision to provide the portfolio owner with tailored financial overlays based on his/her exposure adjustment rules.

In some embodiments, the financial overlay computer system 104 may send the financial overlay decision with the financial overlay information 130 to the outside owner's computer system 122. In some embodiments, the financial overlay computer system 104 uses the entity contract information 116 to communicate with the outside owner. The portfolio owner may sell the securities it owns in sector F based on the financial overlay decision. The proceeds may be distributed evenly across the remaining nine sectors and the portfolio owner will have a resulting financial portfolio 126 as shown in FIGS. 1A and 1B.

In some embodiments, the investment strategy module 111 may analyze market data 128 periodically in order to continuously monitor the performance of different market sectors to minimize loss in the overall financial owner portfolio. Investment strategy module 111 may compute and store market analysis data such as historic price return data, market volatility measures for different market sectors over time, and forecasted performance relative to cash returns for each market sector over time as market analysis data 134 in database 112. Upon periodically computing market analysis data 134, in some embodiments, the financial overlay decision is updated periodically, aperiodically, at a frequency, at discrete time periods, weekly, bi-weekly, monthly, and daily. In such cases, the process of determining the financial overlay decision is performed again. When the process is updated, the financial overlay generator 108 may determine that sector B should be sold. However, in this instance, the financial overlay generator 108 may determine that the proceeds from the sale of investments in sector B should be invested in cash. If the portfolio owner follows the financial overlay decision provided to his/her computer system 122 via overlay information 133, the portfolio owner will have the financial portfolio 132 as shown in FIG. 1B. The maximum amount that can be invested in any individual sector may be set based on the preferences of the entity holding the securities. Thus, the trigger for converting investments to cash may be set at various trigger points. As financial overlay decision on which market sectors to remove and which to retain in the owner's financial portfolio is computed, financial overlay computer system 104 may store an indication of the percentage of a financial owner's portfolio each market sector comprises as index monitoring data 132 in database 112. Financial overlay computer system 104 may also store the most up to date profitability prediction associated with each market sector as index monitoring data 132.

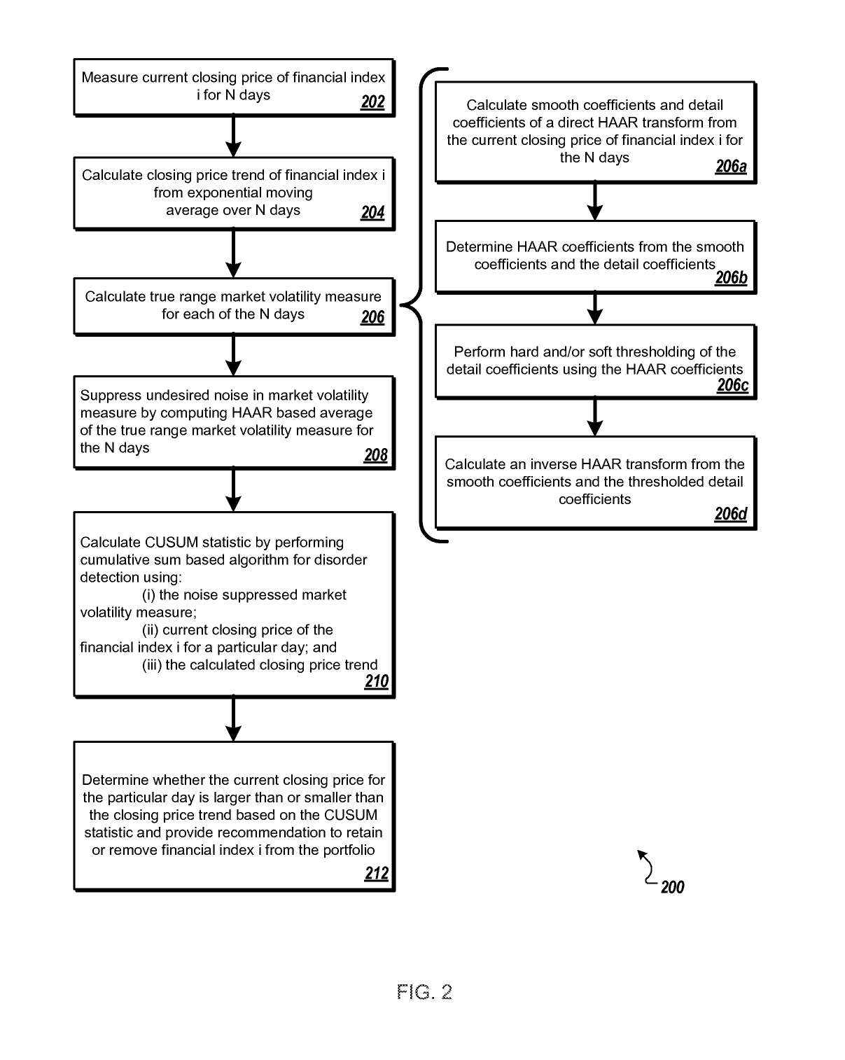

FIG. 2 shows steps of a method 200 performed by the overlay computer system 104, including the investment strategy module 111, in determining a recommendation and/or action to sell or retain a particular sector. In step 202, the current closing price of a particular financial index i (e.g., corresponding to one of sectors A through J illustrated in FIGS. 1A and 1B) is measured (e.g., determined or obtained) for each of N days, e.g., for N consecutive business days. In step 204, the closing price trend of the index i is calculated from an exponential moving average over N days. In step 206, a true range market volatility measure is calculated for each of the N days.

Determination of the true range market volatility measure in step 206 may involve, as shown at 206a, for example, calculating smooth coefficients and detail coefficients of a direct HAAR transform from the current closing price of financial index i for the N days, as discussed in more detail herein. In step 206b, HAAR coefficients are determined from the smooth coefficients and the detail coefficients. In step 206c, hard and/or soft thresholding of the detail coefficients is performed using the HAAR coefficients. In step 206d, an inverse HAAR transform is computed from the smooth coefficients and the thresholded detail coefficients.

In step 208, undesired noise in the market volatility measure is suppressed by computing a HAAR-based average of the true range market volatility measure for the N days. Then, in step 210, a CUSUM statistic is calculated by performing a cumulative sum-based algorithm for disorder detection using (i) the noise-suppressed market volatility measure; (ii) the current closing price of the financial index i for a particular day; and (iii) the calculated closing price trend. Then, in step 212, the processor determines whether the current closing price for the particular day is larger than or smaller than the closing price trend based on the CUSUM statistic, and provides a recommendation (or order/direction/instruction) to retain the financial index i from the portfolio, or to remove the financial index i from the portfolio. The overlay may be updated to reflect the recommendation and/or order/direction/instruction.

In some embodiments, investment strategy module 111 implements a trading algorithm based on a cumulative sum sequential analysis technique (CUSUM) to monitor change in the closing price of a financial investment. The algorithm extracts relevant information from a given stock market index, part of financial market data 128, in order to make intelligent decisions whether to keep an index on the market or take it out in order to obtain good values of decision quality metrics such as high returns and low MaxDrawDown. Such an algorithm processes normalized volatility values and current closing prices and trends processed by a CUSUM procedure to detect changes in current closing price behavior of financial investments.

In some embodiments, market data 128 includes data from a variety of investments. The market data 128 may include current valuations, past valuations, data about the investments, forecasts, and/or data relating to market sectors. The market data 128 may also include the highest price of each financial investment for a given day, the lowest price of each financial investment for a given day, and the closing price of each financial investment for a given day. In some embodiments, market data 128 is received daily with the lowest price, highest price, and closing price of all financial investments for that day and such data may be stored in database 112 as index monitoring data 132. In another embodiment, several days' worth of market data 128 is received at once.

In some embodiments, investment strategy module 111 collects or accesses a time series of values related to the financial index. These values are the highest price of each financial investment for a given day, the lowest price of each financial investment for a given day, and the closing price of each financial investment for a given day. The investment strategy module 111 uses the accessed price data of the financial index to determine a volatility measure of the financial index. The investment strategy module 111 also determines a closing price trend of the financial index. The investment strategy module 111 analyzes the closing price trend and the measure of volatility to determine the investment strategy recommendation.

In some embodiments, investment strategy module 111 compares the current closing price of a financial index against a closing price trend of the investment in order to decide whether to retain the financial index or to remove it from the owner's financial portfolio. A volatility measure of the financial investment price is required to normalize the closing price data so that such a closing price trend can be computed and so that an accurate comparison between the current closing price of a given day can be compared against the closing trend to make a financial decision while compensating for market volatility (i.e., fluctuations in the price data).

In some embodiments, a true range natural volatility measure is used to normalize the current closing price. Since true range volatility is a day-to-day measure, noise is inevitable when present in the underlying price series Pₜ^{h}, Pₜ^{l} and Pₜ^{c} (highest price, lowest price, and closing price on a given day). As a result of such noise, the majority of the price series lacks confidence and stability. In order to suppress undesired noise in the true range series and estimate the volatility time-series Vₜ, t=1, 2, . . . an averaging process is necessary. In some embodiments, investment strategy module 111 may use a Haar based averaging procedure to estimate volatility in the prices of the current closing price of a financial index. In other embodiments, investment strategy module 111 may use a true range volatility

In some embodiments, investment strategy module 111 estimates the volatility of the price of the financial investment based on the true range of the financial investment's price data. Some volatility measure is necessary to normalize current closing price of the financial investment. The true range volatility TR is a natural daily volatility measure is calculated using the formula (1), wherein Pₜ^{h}, t=0, 1, . . . is the highest price for the day t, Pₜ^{l}, t=0, 1, . . . is the lowest price for the day t, Pₜ^{c}, t=0, 1, . . . is the closing price for the day t. Investment strategy module 111 may calculate volatility estimates for logarithmic returns of the initial price time series. The robustness of the volatility estimates increases with a higher number of intra-day price data points that are received by computing device 104.

TRₜ=max{Pₜ^{h}−Pₜ^{l},|PPₜ^{h}−Pₜ₋₁^{c}|,|Pₜ^{l}−Pₜ₋₁^{c}|}, t=2,3, . . . (1)

In some embodiments, computing device 104 may also calculate logarithmic returns for the price time series. Investment strategy module 111 may calculate logarithmic returns for the price time series using the following formula (2). Investment strategy module 111 calculates logarithmic returns in order to perform a Haar based averaging procedure to estimate volatility in the prices of the current closing price of a financial index. To suppress undesired noise in the TR series and estimate a volatility time-series Vₜ, t=1, 2, . . . such Haar averaging may be used.

$${r}_{t}^{TR} = max \{ \vert log ( \frac{{P}_{t}^{h}}{{P}_{t}^{l}} ) \vert , \vert log ( \frac{{P}_{t}^{h}}{{P}_{t - 1}^{c}} ) \vert , \vert log ( \frac{{P}_{t}^{l}}{{P}_{t - 1}^{c}} ) \vert \} \qquad ( 2 )$$

In some embodiments, investment strategy module 111 estimates volatility in the price data of the financial index using a Haar based averaging procedure. The estimate \hat{V}ₜ² of the volatility Vₜ² for the day t is computed by Haar based averaging of the True Range TRₜ time-series. The values TRₛ, s=t−L+1, t−L+2, . . . , t are taken as input to a Haar based averaging algorithm. Parameter L is (the HaarLen window) is a length of the samples used for averaging based on Haar transformation. The value of L may equal to some power of 2. Investment strategy module 111 may obtain as output averaged time-series \hat{σ}₍ₕ₎²(s), s=t−L+1, t−L+2, . . . , t. The last value \hat{σ}₍ₕ₎²(t), corresponding to time t, is used as an estimate \hat{V}ₜ² of the squared volatility at time t.

In some embodiments, investment strategy module 111 models the time series of true range logarithmic returns of the financial investment's price as a non-stationary process. Applying the Haar transform to the time series of logarithmic returns of the financial index involves modeling the logarithmic returns time series as a process with unconditional non-stationary volatility. The time series of true range logarithmic returns (rₜ^{TR}) of the financial investment's price is modeled as a non-stationary process Xₜ having unconditional non-stationary volatility. In some embodiments, the non-stationary model for log-returns of stock price, denoted by Pₜ, t=0, . . . , T for known daily values of financial instrument, or stock price, is calculated using

$${X}_{t} = log ( \frac{{P}_{t}}{{P}_{t - 1}} ) , t = 1 , … , T .$$

Such a model Xₜ has the form shown in formula (3), where T is a time length of the duration of the process Xₜ for which market data is captured such that the values of T consist of the powers of 2. Furthermore, σ(t)>0 is a bounded piece wise deterministic function realizing unconditional non-stationary volatility, and Yₜ is a bounded stationary process with zero mean and unit variance.

Xₜ=σ(t)·Yₜ, t=1, . . . ,T, (3)

In some embodiments, investment strategy module 111 models a series of logarithmic returns as a process with unconditional non-stationary volatility using squared log-returns of the values of the time series of measured financial investment prices (rₜ^{TR})². The series of logarithmic returns modeling square true range logarithmic returns is defined by formula (4). The series of logarithmic returns is required to compute Haar coefficients that will be used in calculating a model of the volatility function. In addition, the following condition ∃J∈ [symbol] ,J>0:T=2^{J}, is assumed in calculating the volatility model. Available realization of t=1, 2, . . . , T are averaged in order to consistently estimate the piece-wise constant function σ²(t), t=1, 2, . . . , T

Xₜ²=(rₜ^{TR})² (4)

In some embodiments, investment strategy module 111 may smooth the true range logarithmic returns time series to calculate the volatility of the logarithmic returns. In order to smooth the true range logarithmic returns, smoothing coefficients and detail coefficients of a direct Haar transform are calculated using formulas (5) and (6), wherein β_{J,k}=Xₖ² and where k is defined as ∀k=1, . . . , 2^{J} The smoothing and detail coefficients are calculated for use in applying an inverse Haar transform to the time series of values of the financial index price to determine a measure of volatility in the financial index prices.

$$\begin{matrix}{β}_{j , k} = \frac{1}{\sqrt{2}} [ {β}_{j + 1 , 2 k - 1} + {β}_{j + 1 , 2 k} ] ( smooth coefficients ) & ( 5 ) \\ {α}_{j , k} = \frac{1}{\sqrt{2}} [ {β}_{j + 1 , 2 k - 1} - {β}_{j + 1 , 2 k} ] ( detail coefficients ) & ( 6 )\end{matrix}$$

In order to calculate the smoothing coefficients and detail coefficients, the following can be assumed. The value J_{ε} is selected in such a way that 2^{J}^{_{ε}}=O(T^{1-ε}) for some ε>0, which defines some technical condition on the moments of the process Yₜ, t=1, 2, . . . , T (for applications ε=0 can be taken). In addition, tⱼ, j=0, 1, . . . , J_{ε}−1 is a set of threshold values. Furthermore, the set U_{ε} of pairs (j, k) has the form U_{ε}={(j,k)|j=0, 1, . . . , j<J_{ε}, k=1, 2, . . . , 2^{j}}.

In some embodiments, the smoothing and detail coefficients are used to calculate a denoising coefficient to be used in the volatility estimation calculation. Investment strategy module 111 calculates denoising coefficient γ_{J,k} from the smooth coefficients and detailed coefficients as shown in formula (7). The denoising coefficient, along with smooth coefficients, and threshold values of the detailed coefficients are stored in database 212 as a Haar transform coefficients 224.

$${γ}_{j , k} = \frac{{α}_{j , k}}{{β}_{j , k}} , \qquad ( 7 )$$

In some embodiments, investment strategy module 111 applies thresholding to the detail coefficients. Thresholding adjusts the detail coefficients to remove unwanted data noise in the volatility estimation calculation. Thresholding can be applied to detail coefficients using either a hard thresholding rule or a soft thresholding rule. Thresholding is applied to the detail coefficients before an inverse Haar transform is applied to the detail coefficients, smoothing coefficients and denoising coefficients to generate a volatility measure of the price of the financial index.

For all values of j such that ∀j=J−1, J−2, . . . , 0 and values of k such that k=1, 2, . . . , 2^{j}, investment strategy module 111 may perform thresholding of detail coefficients α_{j,k} using hard thresholding rule δ^{(h)} (hard thresholding), as shown in formula (9), wherein ∀j=J−1, J−2, . . . , 0 and k=1, 2, . . . , 2^{j} and II(A) is an indicator of the event A, (x)+=max(0,x). wherein V, an acceptable set of j and k values used in the thresholding rule has the form as shown in (8).

$$\begin{matrix}{V}_{∈} = \{ ( j , k ) \vert j = 0 , 1 , … , j < {J}_{∈} , k = 1 , 2 , … , {2}^{j} \} & ( 8 ) \\ {δ}^{( h )} ( {α}_{j , k} ) = \{ \begin{matrix}{α}_{j , k} \cdot 𝕀 \{ \vert {γ}_{j , k} \vert > {t}_{j} \} , & ( j , k ) ∈ {V}_{∈} \\ 0 , & ( j , k ) ∉ {V}_{∈}\end{matrix} & ( 9 )\end{matrix}$$

In some embodiments, investment strategy module 111 may apply soft thresholding rule to the detail coefficient using formula (10).

$${δ}^{( s )} ( {α}_{j , k} ) = \{ \begin{matrix}{β}_{j , k} \cdot sign ( {α}_{j , k} ) \cdot ( {\vert {γ}_{j , k} \vert - {t}_{j} )}_{+} , & ( j , k ) ∈ {V}_{∈} \\ 0 , & ( j , k ) ∉ {V}_{∈}\end{matrix} \qquad ( 10 )$$

In some embodiments, investment strategy module 111 may be able to pick from three different types of thresholding policies to threshold the detail coefficients that are used to calculate the inverse Haar transform required to produce the volatility estimate. For example, investment strategy module 111 may consider one of three different types of thresholding policies to apply thresholding to the detail coefficients. In addition, investment strategy module 111 may also accept an indication of whether soft or hard thresholding is to be used to perform thresholding on the detail coefficients. In some embodiments, the three different types of thresholding policies are asymptotic, Beta, and NC-Beta.

In some embodiments, investment strategy module 111 may select asymptotic thresholds. In such an embodiment, the proposed estimates of volatility are mean square consistent and the threshold tⱼ is computed using formula (11).

$${t}_{j} = {2}^{- \frac{J - j - 1}{2}} \sqrt{2 log ( N )} , j = J - 1 , J - 2 , … , 0 \qquad ( 11 )$$

In some embodiments, investment strategy module 111 selects a thresholding policy to provide a noise free reconstruction of the volatility value (i.e., the Beta thresholding policy). Often the market data 128 is subject to a great degree of data noise. In order to accurately reconstruct the volatility function without noise, the investment strategy module 111 may calculate the threshold tⱼ using formula (12) where

$${s}_{j} = {Φ}^{- 1} ( \frac{1 - p ( T )}{2} \cdot \vert {2}^{J - j - 1} )$$

is a

$$\frac{1 - p ( T )}{2}$$

-quantile of student distribution with 2^{J-j-1} degrees of freedom.

$${t}_{j} = \sqrt{\frac{{s}_{j}}{{s}_{j} - {2}^{J - j - 1}}} , j = J - 1 , J - 2 , … , 0 \qquad ( 12 )$$

In some embodiments, the noise free reconstruction policy involves making a few assumptions with respect to the denoising coefficient. For example, it needs to be assumed that [symbol] {∪ⱼ₌₀^{J-1}∪ₖ₌₁²^{^{j}}(|γ_{j,k}|>tⱼ)}→0 for T→∞ (J=log₂ T) in case there is only noise in the data. Such an assumption is herein referenced as thresholding assumption A.

Furthermore, it can be proved that if Yₜ, t=1, 2, . . . has a normal distribution, then the denoising coefficient can be defined as γ_{j,k}:2β(2^{J-j-2},2^{J-j-2})−1, where β(m, m) is a beta-distribution with parameters m and m. Thus, if we select tⱼ=J−1, J−2, . . . , 0 such that

$$ℙ ( \vert {γ}_{j , k} \vert < {t}_{j} ) = p ( T ) = 1 - \frac{1}{( {2}^{J} - 1 ) \sqrt{π J log 2}} , J = {log}_{2} T ,$$

(thresholding assumption B) then the probability (as defined by thresholding assumption A) will be bounded from above by the quantity

$$\frac{1}{\sqrt{π J log 2}}$$

and will decrease to zero for T→∞.

It is well-known that if random variable ξ has student distribution with ν degrees of freedom, then random variable

$$η = \frac{1}{2} + \frac{1}{2} \frac{ξ}{\sqrt{v + {ξ}^{2}}}$$

has beta distribution with parameters

$$\frac{v}{2} and \frac{v}{2}$$

Thus from this considerations and formula of thresholding assumption B the threshold tⱼ may be computed according to the formula (12).

In this noise-free reconstruction thresholding policy, a threshold is selected such that the probability that the Haar denoising coefficient will be less than the threshold tⱼ is set to a constant as shown by

$$ℙ ( \vert {γ}_{j , k} \vert < {t}_{j} ) = p ( T ) = 1 - \frac{1}{( {2}^{J} - 1 ) \sqrt{π J {log}_{2}}}$$

such that J=log₂ T (thresholding assumption B).

In some embodiments, investment strategy module 111 selects a threshold policy to provide a noise free reconstruction of the volatility value while using a non-constant probability p(T) that Haar denoising coefficient will be less than the threshold tⱼ (i.e., the NC-Beta policy). Such a policy does not require assuming that probability p(T) in thresholding assumptions A and B depends only on J=log₂ T. Instead of modeling p(T) as constant across scales j, more accurate volatility estimates can be obtained in some cases allowing p(T) to decrease from finer to coarser scales. Thresholding module 211 may use pⱼ(T), j=J−1, J−2, . . . , 0 instead of constant p(T) such that

$${p}_{j} ( T ) = \frac{j}{J - 1} \cdot {p}_{J - 1} ( T ) + \frac{J - 1 - j}{J - 1} .$$

p₀(T) where p_{J-1}(T)=p(T) and such that the value of

$${P}_{0} ( t ) = \frac{p}{100} \cdot {p}_{J - 1} ( T ) .$$

p selected is a some integer from the set [95, 96, . . . , 100].

For such sequence of probabilities pⱼ(T), j=J−1, J−2, . . . , 0 the threshold can be calculated using the formula (12) to calculate the corresponding threshold values j=J−1, . . . , 0. Therefore, for defining threshold values j=J−1, . . . , 0 a noise-free reconstruction with non-constant probability strategy can be used.

A script, such as a MATLAB script, can consider six different estimates for the detail coefficients, and thereby for the resulting volatility estimates. Estimates obtained using an asymptotic thresholding policy, or using a noise free reconstruction thresholding policy, or using a noise free reconstruction thresholding policy with non constant probability, can be computed using either hard treshoding or soft thresholding. Such scripts can additionally modify the values of p, and J in order to improve overall quality of the volatility estimate model.

Once the detailed coefficients, smoothing coefficients, and denoising coefficients are prepared, investment strategy module 111, in some embodiments, calculates an inverse Haar transform using the smooth coefficient, thresholded detail coefficient, and Haar coefficient. The Haar transform is a wavelet transform used to analyze the localized feature of signals. Similarly, the inverse Haar transform may be used to calculate the volatility function using the captured data points observed from the observed prices of the financial index (i.e., the localize feature of the volatility signal) given the Haar coefficients. Investment strategy module 111 may retrieve the Haar transform coefficients that it has calculated using processes described above to calculate the inverse Haar transform using formulas (13) and (14), wherein \tilde{β}_{0,1}=β_{0,1}.

$${\tilde{β}}_{j + 1 , 2 k - 1} = \frac{1}{\sqrt{2}} [ {\tilde{β}}_{j , k} + {δ}^{( h )} ( {α}_{j , k} ) ] \qquad ( 13 )$$

$${\tilde{β}}_{j + 1 , 2 k} = \frac{1}{\sqrt{2}} [ {\tilde{β}}_{j , k} - {δ}^{( h )} ( {α}_{j , k} ) ] \qquad ( 14 )$$

In some embodiments, the deterministic function σ(t) realizing the unconditional non-stationary volatility estimate can be calculated, by investment strategy module 111, by taking the square root of σ²(t) which can be computed as \hat{σ}₍ₕ₎²(t)=\tilde{β}_{J,t}, t=1, 2, . . . , T. Such an averaging approach can be proved to provide consistent estimate of the function values σ²(t).

In some embodiments, the market volatility in the closing price of a financial investment for a given day is estimated. For example, investment strategy module 111 may calculate volatility Vₜ² for the day t by Haar based averaging of the true range time-series TRₜ for s=t−L+1, t−L+2, . . . , t. as shown in formula (1), reproduced below:

TRₜ=max{Pₜ^{h}−Pₜ^{l},|Pₜ^{h}−Pₜ₋₁^{c}|,|Pₜ^{l}−Pₜ₋₁^{c}|}, t=2,3, . . . (1)

The parameter L, known as the HaarLen window, is proposed to be a large power of 2 (e.g., L=1024), although smaller window size values (e.g., L=256 and L=512) still can produce reasonably accurate results. Upon averaging the true range time series, a time average series \hat{σ}₍ₕ₎²(s), s=t−L+1, t−L+2, . . . , t is obtained. The last value \hat{σ}₍ₕ₎²(t), corresponding to time t, is used as an estimate \hat{V}ₜ² of the squared volatility at time t.

In some embodiments, a forecast of future closing price of a financial index can be determined by extrapolating the volatility measurement. A time series of historical values is accessed to obtain known values of the financial investment closing price Pₜ. Based on these values of known price values, values of future market volatility for the financial investment are forecasted and thereby the future price range at a time t+h in the future is also forecasted.

By observing X₁², . . . , Xₜ² from the volatility model of formula (4), a volatility forecast can be computed for times, t+1, . . . , t+h. Such a mean square optimal forecast can be calculated using formula (15)

σ²(t|t+h)= [symbol] (Xₜ₊ₕ²|X₁², . . . ,Xₜ²)=σ²(t+h) (15)

Since the true value of σ²(t+h) is unknown at time t, an estimate for such a future value can be extrapolated using formula (16), where \hat{σ}²(t) is calculated using any of the current volatility estimates as described above.

σ²(t|t+h)=\hat{σ}²(t) (16)

In some embodiments, the proposed volatility forecasted values do not depend on the forecasting horizon, h. In some embodiments, a forecasting horizon, h, is used to predict the volatility value given the piece wise assumption of the volatility function σ(t). According to the model Wₜ² from the volatility model of formula (4), such a future price for the financial index can be calculated using formula (17) by making the assumption (18) for the volatility model.

Pₜ₊ₕ=Pₜe^{X}^{ₜ₊₁}^{+ . . . +X}^{ₜ₊ₕ} (17)

[symbol]

[(Xₜ₊₁+ . . . +Xₜ₊ₕ)²|P₀, . . . ,Pₜ]= [symbol] (Xₜ₊₁²|P₀, . . . ,Pₜ)+ . . . + [symbol] (Xₜ₊ₕ²|P₀, . . . ,Pₜ)=σ²(t|t+1)+ . . . +σ²(t|t+h)≈h·\hat{σ}²(t). (18)

Assuming that Yₜ, t=1, 2, . . . has a normal distribution, the forecast of the approximate price range at time t+h can be computed with probability θ, wherein θ is between 0 and 1, using formula (19) where s_{θ}=−Φ⁻¹((1−θ)/2) is a (1−θ)/2 quartile of a (0,1) normal distribution.

(Pₜ·e^{-s}^{_{θ}}^{\hat{σ}(t)\sqrt{h}},Pₜ·e^{+s}^{_{θ}}^{\hat{σ}(t)\sqrt{h}}) (19)

In some embodiments, a predefined set of historical values can be used to estimate the deterministic volatility function σ(t) for the current moment of time t. For example, a HaarLen window size L may be used in such a volatility estimation, where L is proposed to be a large power of 2 (e.g., L=1024), although smaller window size values (e.g., L=256 and L=512) still can produce reasonably accurate results. Due to the locality of the Haar transform, the window size does not influence the obtained forecasted future price significantly.

Accordingly, to calculate future price forecasts, values of closing price Pₜ, the estimated value of σ(t) are required. A script involved in such forecasting may adjust the values of the covering probability θ, window size L, and the forecasting horizon h in order to improve overall quality of price range forecasts. The script may accept values of window size L, closing price value of the financial index, a threshold type and threshold value and return as outputs the closing price range forecast for the time horizon h.

In some embodiments, the closing price trend may be estimated using the current closing price obtained from a single day of trading instead of using multiple historic closing price values. For example, the closing price trend Pₜ^{c,n} may be estimated by using an exponential moving average formula (20) and the current closing price Pₜ^{c}. According to formula (20), the where the base case is defined as P₁^{c,n}=P₁^{c} and

$$α = \frac{2}{n + 1}$$

is the coefficient of decay (n is a tuning coefficient measured in days). This parameter can be tuned by based on the price data. In some embodiments, values of n can be considered such that n∈{5, 10, 15, . . . , 150}. In general, a value of n=100 usually produces good results.

Pₜ^{c,n}=αPₜ^{c}+(1−α)Pₜ₋₁^{c,n} (20)

In some embodiments, investment strategy module 111 determines an investment strategy decision as to whether to retain or remove a financial index from the owner's financial portfolio. A cumulative sum analysis technique (CUSUM) may be used to form a decisional rationale in determining whether to keep a financial investment in the market. If it is determined that the current closing price is significantly larger than the trend of closing price time-series Pₜ^{c,n} taking volatility values into account, then a decision is made to retain the financial investment in the owner's financial portfolio. However, if a determination is made that the current closing price is significantly smaller than the trend of closing price time-series Pₜ^{c,n}, taking volatility values into account, the financial investment is removed from the owner's financial portfolio.

In some embodiments, investment strategy module 111 applies a CUSUM based algorithm for detecting upward or downward drifts in the closing price trend.

In some embodiments, it is determined whether there is any upward drift in the closing price trend. A CUSUM statistic for upward drift gₜ⁺, t=1, 2, . . . may be calculated according to formula (21), where the initial CUSUM statistic value g₁⁺=0 and γ⁺∈(0,∞) is an upward trend damping constant.

$${g}_{t}^{+} = max ( {g}_{t - 1}^{+} + \frac{{γ}^{+} {P}_{t}^{c , n}}{{\hat{V}}_{t}^{2}} ( {P}_{t}^{c} - {P}_{t}^{c , n} ( 1 + \frac{{γ}^{+}}{2} ) ) , 0 ) \qquad ( 21 )$$

The upward trend damping constant parameter can be tuned based on the closing price data. This upward trend damping parameter can be varied within the interval (0,2). An upward trend damping parameter value of 2 indicates that we assume that after disorder, the closing price can increase more than twice in value.

In some embodiments, two increase threshold values, h₂⁺ and h₁⁺ are selected such that h₂⁺>h₁⁺. In an embodiment, a value for h₂⁺ is set such that h₂⁺=(1+δ⁺)h₁⁺, where δ⁺=0.1. In some embodiments, the value of the CUSUM statistic value gₜ⁺ is monitored for a period of time (i.e., one week) to determine the investment strategy decision for the upcoming time period. If it is determined that the CUSUM statistic g₁⁺ falls between the upper and lower increase thresholds h₂⁺ and h₁⁺ at a point of time in the monitored time period, then it a decision is made to retain the financial index in the owner's financial portfolio for the next week and continue calculation of the CUSUM statistic for subsequent points of time in that time period. If a determination is made that the CUSUM statistic gₜ⁺ exceeds the upper increase threshold h₂⁺ at a point of time in the monitored time period, then a decision is made to retain the financial index in the owner's financial portfolio for the next week and reset the value of the CUSUM statistic to zero (e.g., store a value of zero as CUSUM statistic) and restart calculation of the CUSUM statistic for subsequent points of time in that time period. If it is determined that the CUSUM statistic gₜ⁺ falls below the lower increase threshold h₁⁺ at a point of time in the monitored time period, then a decision is made to maintain the current value of the CUSUM statistic for subsequent points of time in that time period.

In some embodiments, it is determined whether there is any downward drift in the closing price trend and based on the determination, a CUSUM statistic is updated. A CUSUM statistic for downward drift gₜ⁻, t=1, 2, . . . is calculated according to formula (22), where the initial CUSUM statistic value g₁⁻=0 and γ⁻∈(0,1) is a downward trend damping constant.

$${g}_{t}^{-} = max ( {g}_{t - 1}^{-} - \frac{{γ}^{-} {P}_{t}^{c , n}}{{\hat{V}}_{t}^{2}} ( {P}_{t}^{c} - {P}_{t}^{c , n} ( 1 - \frac{{γ}^{-}}{2} ) ) , 0 ) , \\ t = 1 , 2 , … , \qquad ( 22 )$$

The downward trend damping constant parameter can be tuned based on the closing price data This downward trend damping parameter can be varied within the interval (0,0.5). A downward trend damping parameter value of 0.5 indicates that we assume that after disorder, the maximum amount that the closing price can increase is twice that of its previous value. In some embodiments, the upward and downward trend damping parameters can be tuned.

In some embodiments, two decrease threshold values, h₂⁻ and h₁⁻ are selected such that h₂⁻>h₁⁻. In an embodiment, a value for h₂⁻ is set such that h₂⁻=(1+δ⁻)h₁⁻, where δ⁻=0.1. In some embodiments, the value of the CUSUM statistic value gₜ⁻ is monitored for a period of time (i.e., one week) to determine the investment strategy decision for the upcoming time period. If it is determined that the CUSUM statistic gₜ⁻ falls between the upper and lower decrease thresholds h₂⁻ and h₁⁻ at a point of time in the monitored time period, then a decision is made to remove the financial index in the owner's financial portfolio for the next week and continue calculation of the CUSUM statistic for subsequent points of time in that time period. If it is determined that the CUSUM statistic gₜ⁻ exceeds the upper decrease threshold h₂⁻ at a point of time in the monitored time period, then a decision is made to remove the financial index in the owner's financial portfolio for the next week and reset the value of the CUSUM statistic to zero and restart calculation of the CUSUM statistic for subsequent points of time in that time period. If a determination is made that the CUSUM statistic gₜ⁻ falls below the lower decrease threshold h₁⁻ at a point of time in the monitored time period, then a decision is made to maintain the current value of the CUSUM statistic for subsequent points of time in that time period.

If a decision is made to retain the financial index in the owner's financial portfolio during a given time within the monitored period of time before the end of the period and later on in the same time period, a that decision is reversed (i.e., decision is made to remove the financial index from the owner's financial portfolio), a final decision is made to remove the financial index from the owner's financial portfolio.

If decision about whether to retain or remove the financial index in the owner's financial portfolio is not made after monitoring the closing price against the CUSUM statistic for the entire duration of the time period, the decision that was made in the previous time period is used for the subsequent time period.

In some embodiments, the investment strategy module 111 generates one or more outputs. In some embodiments, investment strategy module 111 may output result metrics of true range, Haar Volatility, and the number of trade actions during the considered time period. In some embodiments, the investment strategy module 111 calculates and outputs the value of Maximum Drawdown, which is an economical measure of the decline from a historical peak of the closing price for a given financial index (typically the cumulative profit or total open equity of a financial trading strategy). If X=X(0), for t≧0 is a random process with X(0)=0, the drawdown at time T, denoted D(T) is defined as shown in formula (23).

$$D ( T ) = max \{ 0 , {max}_{t ∈ ( 0 , T )} X ( t ) - X ( T ) \} \qquad ( 23 )$$

The maximum drawdown (MDD) is the drawdown up to time T over the history of the variable D(T). It is mathematically defined using formula (24).

$$M D D ( T ) = {max}_{r ∈ ( 0 , T )} [ {max}_{t ∈ ( 0 , r )} X ( t ) - X ( τ ) ] \qquad ( 24 )$$

In some embodiments, investment strategy module 111 outputs a table listing decision date and true range, Maximum Drawdown obtained till this decision date. In some embodiments, investment strategy module 111 may output a table listing decision date and the binary decision of whether to retain or to remove the financial index from the owner's financial portfolio.

In some embodiments, volatility and drift of closing prices of financial indexes are non-stationary, so in order to make an investment strategy decision reliably, investment strategy module 111 may iteratively update an estimate of current volatility value, and iteratively update an estimate of current drift value.

In some embodiments, the values of the lower increase and lower decrease thresholds h₁⁺, h₁⁻ are tuned using multiple values uniformly spaced apart in an interval, for example, (0,1). This interval is given as a very rough estimate and in fact may depend on the range of variation of upward and downward trend damping constant parameters γ⁺, γ⁻. The final interval appropriate for the upward selection in the production version of the program, may be selected on the basis of computational experiments.

In some embodiments, for different levels of volatility, different current closing price shifts are considered as being statistically significant. This means that values of parameters γ⁺, γ⁻ are selected while taking historical average volatility level into account. For example, for current moment of time t and time interval Δ during which parameters are tuned (i.e., using values of financial index corresponding to the moments of time from the interval [t−Δ+1, t]), parameters of the CUSUM algorithm are estimated. The estimated parameters are applied for making decisions for future moments of time t+1, t+2, etc. Parameter Δ can be determined as the difference in time between the starting date of the interval for out-of-sample decision making and the starting date of the interval used for learning the CUSUM algorithm (i.e., ZeroDate).

In some embodiments, the strength of the variations with respect to each trend level is calculated. For example, the value of

$${γ}_{S} = \frac{\vert {P}_{s}^{c} - {P}_{s}^{c , n} \vert}{{P}_{s}^{c , n}}$$

is calculated for each s∈[t−Δ+1, t]. A histogram of typical γₛ values may also be constructed. Some empirical quantiles of this histogram may be used as values of γ⁺, γ⁻. In an embodiment, a user of system 100 may define relative values of γ⁺, γ⁻ given by percentages of the corresponding empirical quantiles.

In constructing a reliable and efficient trading algorithm, the following Decision Statistics and Decision Making algorithm may be considered.

Decision Statistics (DS) are calculated on the basis of index values to “extract” predictable components of the index sufficient for making decisions about the market state and metrics (for example, TotalReturn and Calmar Ratio), characterizing such state.

Decision Making (DM) is an algorithm which makes use of the DS and uses a classification rule to transform dynamic trends, contained in DS, into a simple 0-1 segmentation over the DS time-series, appropriate for use in real decision making in the market.

In order to obtain reasonable DS, a theoretical model of decision process can be constructed, in particular, a model for a financial index is elaborated. Here, it can be assumed that current closing price follows a Gaussian distribution model with some drift value and some variance. So, it is proposed to consider a DS normalized (with respect to the mean value and volatility) value of the current closing price.

In general, volatility and drift of real index are non-stationary, so in order to reliably make decision about whether to retain or remove a financial index, an estimate of current volatility value and drift value are iteratively updated.

In order to perform DM, methods capable of detecting structural changes in behavior of DS are used. For this, the CUSUM rule can be used, which provides a robust method for quickest detection of structural changes and behaves very well in applications.

The CUSUM rule is an optimal method for quickest detection of disorder moment (moment of structural change). However, the optimality is proved only for the case when the parameters after the disorder time is known, which is a rare case in practice. Modifications of the CUSUM rule are presented here that are capable of detecting structural changes even for the case of unknown parameters after such changes occur. Even though it is assumed only the minimal amplitude of the change is known, nevertheless, the CUSUM rule performs well.

Finally, formulas for calculation of CUSUM can be derived as follows. Let us assume that we observe ξ₁, ξ₂, . . . such that ξₖ:N(μ₁,σ²) if k<0, and ξₖ:N(μ₂,σ²) if k≧0, where θ is a disorder time.

In such case the disorder time θ is estimated by the optimal stopping moment. The optimal stopping moment is defined as τ=inf{k:gₖ≧h}, where the CUSUM statistics gₖ is calculated according to the iterative formula (25)

$${g}_{k} = max ( {g}_{k - 1} + \frac{{μ}_{2} - {μ}_{1}}{{σ}^{2}} ( {ξ}_{k} - \frac{{μ}_{1} + {μ}_{2}}{2} ) , 0 ) \qquad ( 25 )$$

Assuming that μ₂=(1+γ⁺)μ₁, where γ⁺>0 is a coefficient defining which minimum upward mean jump we should be able to detect. If the formula (25) is rewritten by taking such relationship between μ₁ and μ₂ into account, then a formula analogous to (21) is found. In the same way assuming that μ₂=(1−γ⁻)μ₁ formula (22) is obtained.

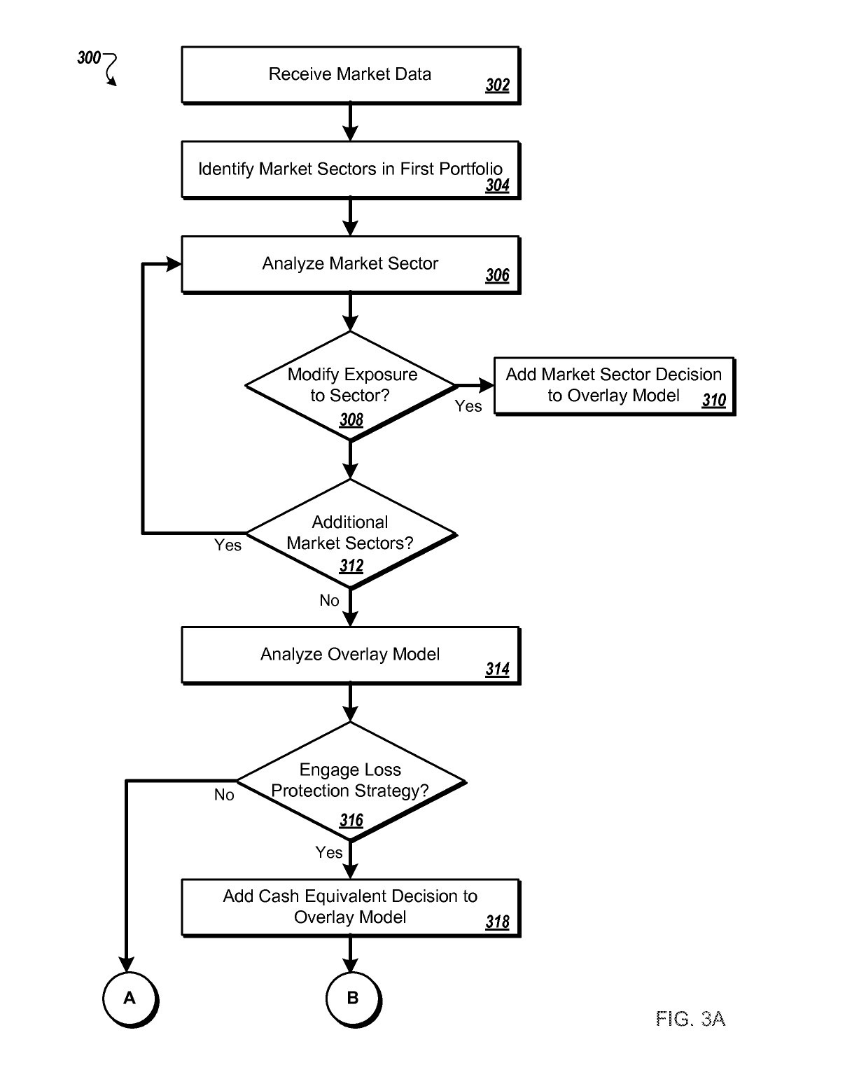

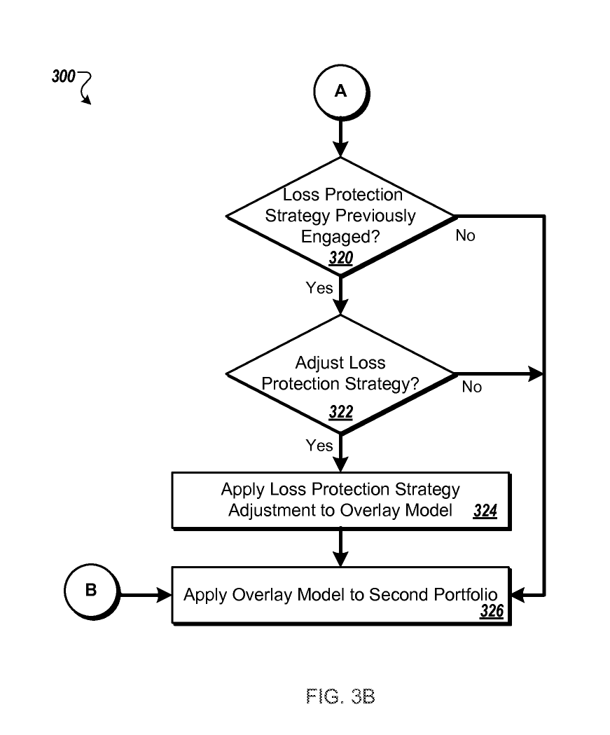

FIGS. 3A and 3B illustrate flow charts describing an example method 300 for determining and providing a financial overlay for investment portfolio adjustment to mitigate financial risk. The method 300, for example, may be performed by the processor of a computing device such as computing device 104 described in relation to FIG. 1A.

In some embodiments, market data is received (302). In some embodiments, the market data may be collected from a number of sources of public information. As described in relation to FIG. 1A, the market data may come from a financial markets computer 102. The market data may include market data from a variety of financial investments. The market data may include current valuations, past valuations, data about the investments, forecasts, and/or data relating to market sectors.

In some embodiments, market sectors are identified in an underlying market portfolio (304). The market sectors may be identified by a sector assessor 106 as described in relation to FIG. 1A. The market sectors may include one or more sectors of the U.S. economy equity markets, one or more indexed equity categories associated with the Standard & Poor 500 index, one or more sectors of fixed income markets, one or more custom sectors combining equities and fixed income, sectors of emerging markets, one or more sectors of commodities, one or more sectors of asset classes uncorrelated to traditional markets, and/or one or more individual stocks in one or more individual companies.

The indexed equity categories may include the categories of basic materials, conglomerates, consumer goods, financial, healthcare, industrial goods, services, technology, and/or utilities. The fixed income markets may include AAA rated corporate bonds, mortgages backed securities, floating rate notes, investment grade bonds, government bonds, 7-10 year treasuries, emerging market bonds, convertible bonds, and/or high yield bonds. The sectors of the emerging markets may include emerging market exchange traded funds such as iShares MSCI Emerging Markets Index, Vanguard MSCI Emerging Markets ETF, or one or more sectors of the U.S. economy correlated with one or more emerging market exchange traded funds.

After identifying the market sectors (304), in some embodiments, the market sectors are analyzed (306) to determine whether to modify exposure to a specific sector (308). The analysis of the market sectors (306) may include analyzing market data such as current valuations, past valuations, data about the investments, forecasts, and/or data relating to market sectors.

Determining whether to modify exposure to the specific sectors (308) may be based on a prediction regarding the future valuation of each specific sector. If exposure to a sector is modified, the processor adds the market sector decision to a financial overlay model (310). Examples of changing exposure to a sector include buying investments, selling investments, hedging investments, and/or converting investments to cash, cash equivalent financial instruments, treasury securities, futures, derivative financial instruments, counter derivatives, a total return swap, establishing short positions with respect to the financial portfolio, and or short term exchange traded funds.

Whether or not a market sector decision is added to the financial overlay model, a determination, in some embodiments, is made whether to analyze additional market sectors (312). In some embodiments, market sectors may be added and/or removed from the underlying market portfolio prior to determining the financial overlay. If additional market sectors are included in the underlying portfolio, the method 300 returns to step 306 and analyzes the remaining market sector(s) again.

In some embodiments, a single market sector is analyzed in step 306 and determines whether to modify exposure to that single market sector in step 308. After determining whether to modify exposure to that single market sector, the processor may determine whether to add additional market sectors to the financial overlay model. If the processor determines that additional market sectors should be added to the model, the processor returns to step 306 and analyzes another single market sector.

In some embodiments, multiple market sectors are analyzed during step 306 before determining whether to modify exposure to any market sectors.

After analysis of all sectors of the first portfolio, in some embodiments, the financial overlay model is analyzed (314). In some embodiments, analyzing the financial overlay model (314) may include determining whether advice needs to be sent to any portfolio owners. This may include analyzing a list of the sectors to which it was determined in step 308 that exposure should be modified. In some embodiments, analyzing the financial overlay model (314) may include updating the financial overlay model based on market sector decisions added to the financial overlay model in step 310 (e.g. do not establish too large of a cash position, do not redistribute but go to cash if a threshold number of sectors are affected, analyze overlay portfolio against a standard index and adjust, etc.).

In some embodiments, an initial value of the financial overlay is determined the first time the financial overlay is generated. After the initial value is determined, subsequent analysis of the financial overlay model may involve determining and applying a modification to the financial overlay model. The modification may be applied to the initial value of the financial overlay model to determine the financial overlay model. The modification may include taking a proportion of the initial value of the financial overlay model to determine the financial overlay model. The modification may be based at least in part on the financial portfolio and/or preferences of the portfolio owner.

In some embodiments, the preferences of the portfolio owner include a request to include market sectors of interest to the portfolio owner in the underlying market portfolio, a request to exclude identified market sectors from the underlying market portfolio, a request that the underlying market portfolio be constructed such that a measure of correlation between the underlying market portfolio and an equity based index exceeds a threshold, a request that the financial portfolio overlay be determined such that application of the financial portfolio overlay to the financial portfolio would not cause a measure of correlation between the financial portfolio and an equity based index to drop below a threshold, regulatory constraints associated with the financial portfolio, contractual constraints associated with the financial portfolio, a maximum limit of a proportion of the financial portfolio in cash equivalent financial instruments requirements imposed by the portfolio owner, and/or investment guidelines/requirements associated with the financial portfolio.

In some embodiments, the financial overlay model is determined based at least in part on an underlying market portfolio. The underlying market portfolio may include market sectors and the financial overlay may be determined based on activity of the market sectors.

In some embodiments, the financial overlay model is determined based at least in part on applying a model to the underlying market portfolio. The model may determine which market sectors of the underlying portfolio are active and/or expected to have a positive performance over a time period.

In some embodiments, the financial overlay model is determined based on binary decisions with respect to the market sectors of the underlying market portfolio.

In some embodiments, the financial overlay model is a quantitative model, a qualitative model, a structured decision model, a computer based software algorithm, a statistical model, and/or a regression model.

In some embodiments, triggering criteria for determining the financial overlay are adjusted based at least in part on the market sectors of interest.

After analyzing the financial overlay model (314), in some embodiments, it is determined whether to engage in a loss protection strategy (316). The loss protection strategy may be applied to the financial portfolio of the portfolio owner to reduce market exposure of the financial portfolio. A loss protection strategy may be engaged based on the financial overlay model.

The loss protection strategy may include advice suggesting a specific market sector or investment should be converted to cash. In some embodiments, the loss protection strategy includes selling investments in one or more sectors based on the financial overlay model and obtaining cash equivalents with the proceeds. In some embodiments, the loss protection strategy includes selling investments in one or more sectors based on the financial overlay model and reinvesting the proceeds in the remaining sectors of the financial portfolio. The proceeds may be reinvested in the remaining sectors of the financial portfolio proportionately or disproportionately.

If the loss protection strategy is engaged, in some embodiments, the cash equivalent decision is added to the financial overlay model (318). Turning to FIG. 3B, after adding the cash equivalent decision, in some embodiments, the financial overlay model is provided to the portfolio owner, and the portfolio owner can apply the financial overlay model to his/her investment portfolio (e.g. the second portfolio) (326). In some embodiments, if a loss protection strategy was not previously engaged, the financial overlay model is provided to the portfolio owner and the portfolio owner can apply the financial overlay model to his/her investment portfolio (326).

If the loss protection strategy is not engaged, in some embodiments, it is determined whether a loss protection strategy was previously engaged (320). In some embodiments, even if a loss protection strategy is engaged, the processor may determine whether a loss protection strategy was previously engaged (320).

In some embodiments, the financial overlay model is compared to the previous overlay model and the similarities and/or differences between the current and previous overlay models are determined. The differences between the previous and current overlay model may be supplied to the portfolio owner so that the owner may implement the changes more readily.

In some embodiments, if a loss protection strategy was previously engaged, the method 300 determines whether to adjust the loss protection strategy. This may require a comparison between the previous and current loss protection strategies to identify similarities and/or differences. In some embodiments, a determination is made regarding adjustment of a loss protection strategy (322) based on the similarities and/or differences between the current and previous loss protection strategies. This may include comparing the differences to determine if the suggested investment strategy is too aggressive, moderate, or passive. In some embodiments, the loss protection strategy adjustments are applied to the financial overlay model (324). For example, assume the financial overlay model determined in step 214 suggests putting 20% of your investment portfolio in cash and the rest in stock B. If the investment portfolio of the portfolio owner includes 30% cash and 70% stock B, then the owner will actually buy stock B instead of selling more stock. Thus, the adjusted overlay model represents the changes the portfolio owner would make to his/her investment portfolio in order to implement the financial overlay model as determined in step 314.

In some embodiments, after applying the loss protection strategy adjustments to the financial overlay model (324), the financial overlay model is provided to the portfolio owner and the portfolio owner applies the financial overlay model to his/her investment portfolio (326).

In some embodiments, applying the financial overlay model includes building a position with respect to the financial portfolio. In some embodiments, building the position includes establishing a new position and/or increasing an existing position. In some embodiments, building the position includes building the position of reduced risk with respect to the financial portfolio. In some embodiments, building the position includes shifting at least a portion of the financial portfolio to the position. In some embodiments, building the position includes building the position in a hedged position to the financial portfolio. In some embodiments, the position is built in cash, cash equivalent financial instruments, treasury securities, futures, derivative financial instruments, counter derivatives, a total return swap, establishing short positions with respect to the financial portfolio, and or short term exchange traded funds.

In some embodiments, the party providing the financial overlay may receive information regarding application of the financial overlay from the party applying the financial overlay if the two parties are different. In some embodiments, a Global Investment Performance Standards (GIPS)-compliant track record may be compiled based at least in part on the information.

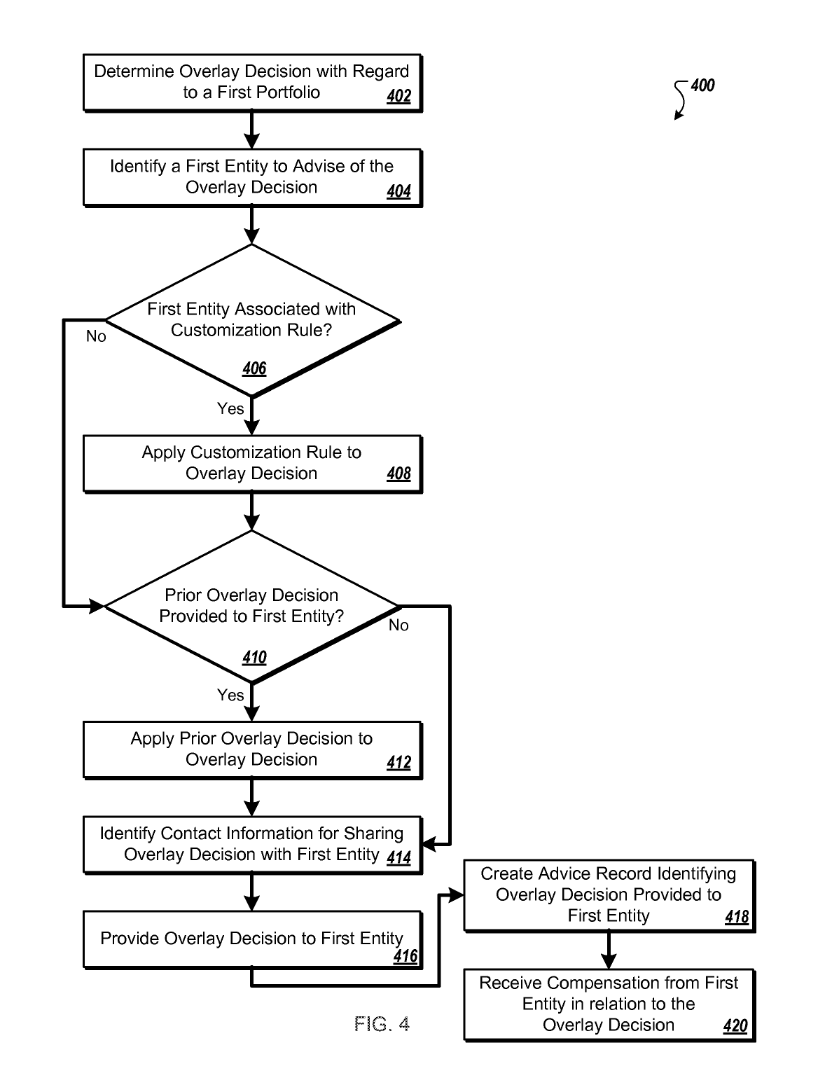

FIG. 4 illustrates a flow chart describing an example method 400 for providing a financial overlay decision to a portfolio owner for investment portfolio adjustment to mitigate financial risk. The method 400, for example, may be performed by the processor of a computing device such as computing device 104 described in relation to FIG. 1A.

In some embodiments, a financial overlay decision with regard to a first portfolio is determined (402). In some embodiments, this is performed according to steps 302, 304, 306, 308, 310, and 312 as described in relation to FIG. 3A.

In some embodiments, the financial overlay decision includes a percentage of the financial portfolio to be in at least one of cash and cash equivalent financial instruments, a proportion of the financial portfolio to be in at least one of cash and cash equivalent financial instruments, and/or an amount of the financial portfolio to be in at least one of cash and cash equivalent financial instruments.

In some embodiments, the financial overlay decision includes percentages of the financial portfolio to be in one or more different categories, proportions of the financial portfolio to be in the one or more different categories, amounts of the financial portfolio to be in the one or more different categories, and/or weights of the financial portfolio to be in the one or more different categories. The different categories may be categories including equities, bonds, and/or cash or cash equivalent instruments.

In some embodiments, the financial overlay decision includes information regarding which market sectors are included in the underlying market portfolio, which market sectors are not included in the underlying market portfolio, any market sector added to the underlying market portfolio, any market sector removed from the underlying market portfolio, which market sectors are expected to perform negatively based on the model, and/or which market sectors are expected to perform positively based on the model.

In some embodiments, the financial overlay decision identifies specific securities to include in the financial portfolio. In some embodiments, the financial overlay decision is a recommended market reduction percentage for the financial portfolio. In some embodiments, the financial overlay decision contains advice regarding whether or not to move a portion of the financial portfolio to cash and/or portfolio construction advice relating to the financial portfolio.

In some embodiments, the financial overlay decision is based at least in part on a trigger event. In some embodiments, the financial overlay decision is based at least in part on an investment strategy, such as an investment strategy with an established track record.

In some embodiments, a portfolio owner to advise of the financial overlay decision is determined (404). The portfolio owners who receive the financial overlay decision may be determined based on who subscribes to a subscription service. In some embodiments, the manager of the investment portfolio may receive overlay decisions as part of the subscription service. The manager may pay the provider of the subscription service in exchange for the subscription.

In some embodiments, it is determined whether the portfolio owner is associated with a customization rule (406). In some embodiments, the portfolio owner may receive tailored overlay decisions for free or for an additional fee.

In some embodiments, if the portfolio owner is associated with a customization rule, the customization rule is applied to the financial overlay decision (408). In some embodiments, the customization rule may include modifying the financial overlay decision based on the financial portfolio of the portfolio owner and/or preferences of the portfolio owner.

In some embodiments, the preferences of the portfolio owner include a request to include market sectors of interest to the portfolio owner in the underlying market portfolio, a request to exclude identified market sectors from the underlying market portfolio, a request that the underlying market portfolio be constructed such that a measure of correlation between the underlying market portfolio and an equity based index exceeds a threshold, a request that the financial portfolio overlay be determined such that application of the financial portfolio overlay to the financial portfolio would not cause a measure of correlation between the financial portfolio and an equity based index to drop below a threshold, regulatory constraints associated with the financial portfolio, contractual constraints associated with the financial portfolio, a maximum limit of a proportion of the financial portfolio in cash equivalent financial instruments requirements imposed by the portfolio owner, and/or investment guidelines/requirements associated with the financial portfolio.

In some embodiments, it is determined if a prior overlay decision was provided to the portfolio owner (410). If a prior overlay decision was provided to the portfolio owner, in some embodiments, the prior overlay decision is applied to the financial overlay decision (412). This enables the financial overlay decision to be modified to account for any differences between the prior overlay decision and the financial overlay decision. In some embodiments, only changes between the financial overlay decision and prior overlay decision will be sent to the portfolio owner. Thus, the portfolio owner may implement the changes more readily. In some embodiments, the changes and the financial overlay decision are provided to the portfolio owner. In some embodiments, the advice provided to the portfolio owner may include a recommendation based at least partially on previous advice provided to the portfolio owner (e.g. if the previous advice recommended moving 25% to cash, do not move additional investments to cash).

In some embodiments, contact information for sharing the financial overlay decision with the portfolio owner is identified (414). This may include accessing entity contact information 116 in database 112 of computer system 114 as described in relation to FIG. 1A.

In some embodiments, the financial overlay decision is provided to the portfolio owner (416). In some embodiments, the financial overlay decision is provided to the portfolio owner in an electronic format. The electronic format may be an email message, a text message, a social media post, an instant message, an electronic signal, a computer-readable signal, an audible message, a visual message, a calendar message, a task reminder, an alarm, and a mobile device function. In some embodiments, the financial overlay decision is provided to the portfolio owner via electronic media, wireless media, and/or a network.

In some embodiments, an advice record is created identifying the financial overlay decision provided to the portfolio owner (418). The advice record, for example, may be used in step 312 when the financial overlay decision is updated. In some embodiments, the financial overlay decision is updated periodically, aperiodically, at a frequency, at discrete time periods, weekly, bi-weekly, monthly, and daily.

In some embodiments, compensation is received from the portfolio owner in relation to the financial overlay decision (420). The compensation may be associated with a subscription service, a one-time fee, per overlay decision fee, or other type of compensation system.

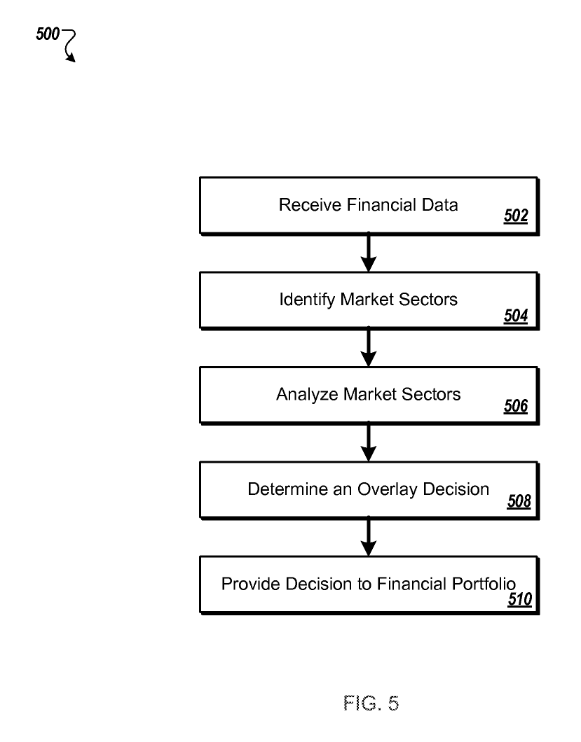

FIG. 5 illustrates a flow chart describing an example method 500 for determining and providing a financial overlay decision for investment portfolio adjustment to mitigate financial risk. The method 500, for example, may be performed by the processor of a computing device such as computing device 104 described in relation to FIG. 1A.

In some embodiments, financial market data pertaining to investments is received (502). The market data may include current valuations, past valuations, data about the investments, forecasts, and/or data relating to market sectors.

In some embodiments, a respective market sector associated with each investment in the market data is identified (504). The sector models may include one or more sectors of the U.S. economy equity markets, one or more indexed equity categories associated with the Standard & Poor 500 index, one or more sectors of fixed income markets, one or more custom sectors combining equities and fixed income, sectors of emerging markets, one or more sectors of commodities, one or more sectors of asset classes uncorrelated to traditional markets, and/or one or more individual stocks in one or more individual companies.

The indexed equity categories may include the categories of basic materials, conglomerates, consumer goods, financial, healthcare, industrial goods, services, technology, and/or utilities. The fixed income markets may include AAA rated corporate bonds, mortgages backed securities, floating rate notes, investment grade bonds, government bonds, 7-10 year treasuries, emerging market bonds, convertible bonds, and/or high yield bonds. The sectors of the emerging markets may include emerging market exchange traded funds such as iShares MSCI Emerging Markets Index, Vanguard MSCI Emerging Markets ETF, or one or more sectors of the U.S. economy correlated with one or more emerging market exchange traded funds.

In some embodiments, each market sector is analyzed to determine the status of the respective market sector (506). This may include analyzing one or more investments from each market sector. The status may be based on a change in behavior and/or a correlation to a financial index.

In some embodiments, an overlay decision is determined associated with one of the market sectors (508). The overlay decision may be based on the status of the market sector. The overlay decision may be a decision to buy, sell, or convert an investment to cash equivalents. In some embodiments, the overlay decision is whether to increase a cash position with respect to the financial portfolio.

In some embodiments, an initial overlay decision is determined the first time the overlay decision is generated. After the initial decision is determined, subsequent determination of the overlay decision may involve determining and applying a modification to the overlay decision. The modification may be applied to the initial decision to determine the overlay decision. The modification may be based at least in part on the financial portfolio and/or preferences of the portfolio owner.

In some embodiments, the preferences of the portfolio owner include a request to include market sectors of interest to the portfolio owner in the underlying market portfolio, a request to exclude identified market sectors from the underlying market portfolio, a request that the underlying market portfolio be constructed such that a measure of correlation between the underlying market portfolio and an equity based index exceeds a threshold, a request that the financial portfolio overlay be determined such that application of the financial portfolio overlay to the financial portfolio would not cause a measure of correlation between the financial portfolio and an equity based index to drop below a threshold, regulatory constraints associated with the financial portfolio, contractual constraints associated with the financial portfolio, a maximum limit of a proportion of the financial portfolio in cash equivalent financial instruments requirements imposed by the portfolio owner, and/or investment guidelines/requirements associated with the financial portfolio.

In some embodiments, the overlay decision is determined based at least in part on an underlying market portfolio. The underlying market portfolio may include market sectors and the financial overlay may be determined based on activity of the market sectors.

In some embodiments, the overlay decision is determined based at least in part on applying a model to the underlying market portfolio. The model may determine which market sectors of the underlying portfolio are active and/or expected to have a positive performance over a time period.

In some embodiments, the overlay decision is determined based on binary decisions with respect to the market sectors of the underlying market portfolio.

In some embodiments, the overlay decision is a quantitative model, a qualitative model, a structured decision model, a computer based software algorithm, a statistical model, and/or a regression model.

In some embodiments, triggering criteria for determining the overlay decision are adjusted based at least in part on the market sectors of interest.

In some embodiments, the overlay decision is provided for use as a financial overlay to a financial portfolio (510). In some embodiments, the overlay decision is at least part of a loss protection strategy to be applied to the financial portfolio to reduce a market exposure of the financial portfolio. The financial portfolio may include investments from the market sector. In some embodiments, the financial overlay is applied to the financial portfolio in order to adjust the holdings of the financial portfolio.

In some embodiments, the overlay decision is provided to a portfolio owner. In some embodiments, the portfolio owner is a manager of the financial portfolio and/or the lawful owner of the financial portfolio or a portion of the financial portfolio. In some embodiments, the portfolio owner does not have direct responsibility for the management of the financial portfolio.

In some embodiments, the portfolio owner may receive the overlay decision as part of a subscription service. The portfolio owner may pay the provider of the subscription service in exchange for the subscription.

In some embodiments, the financial portfolio belongs to an outside entity. In some embodiments, the overlay decision is provided to the outside entity by a first entity. The first entity may not have direct responsibility for management of the second portfolio.

In some embodiments, the financial portfolio belongs to a third party. In some embodiments, a first party provides the overlay decision to an external managing entity and the external managing entity applies the overlay decision to at least a portion of the financial portfolio of the third party. In some embodiments, the overlay decision is provided to the third party and the third party has the external managing entity apply the overlay decision to at least a portion of the financial portfolio. In some embodiments, the external managing entity has at least partial responsibility for management of the second portfolio. In some embodiments, the external managing entity and the second entity are independent of the first entity.

In some embodiments, the party providing the overlay decision may not provide the overlay decision to another party. The party may apply the financial overlay to the financial portfolio of another.

In some embodiments, applying the financial overlay model includes building a position with respect to the financial portfolio. In some embodiments, building the position includes establishing a new position and/or increasing an existing position. In some embodiments, building the position includes building the position of reduced risk with respect to the financial portfolio. In some embodiments, building the position includes shifting at least a portion of the financial portfolio to the position. In some embodiments, building the position includes building the position in a hedged position to the financial portfolio. In some embodiments, the position is built in cash, cash equivalent financial instruments, treasury securities, futures, derivative financial instruments, counter derivatives, a total return swap, establishing short positions with respect to the financial portfolio, and or short term exchange traded funds.

In some embodiments, the party providing the financial overlay may receive information regarding application of the financial overlay from the party applying the financial overlay if the two parties are different. In some embodiments, a Global Investment Performance Standards (GIPS)-compliant track record may be compiled based at least in part on the information.

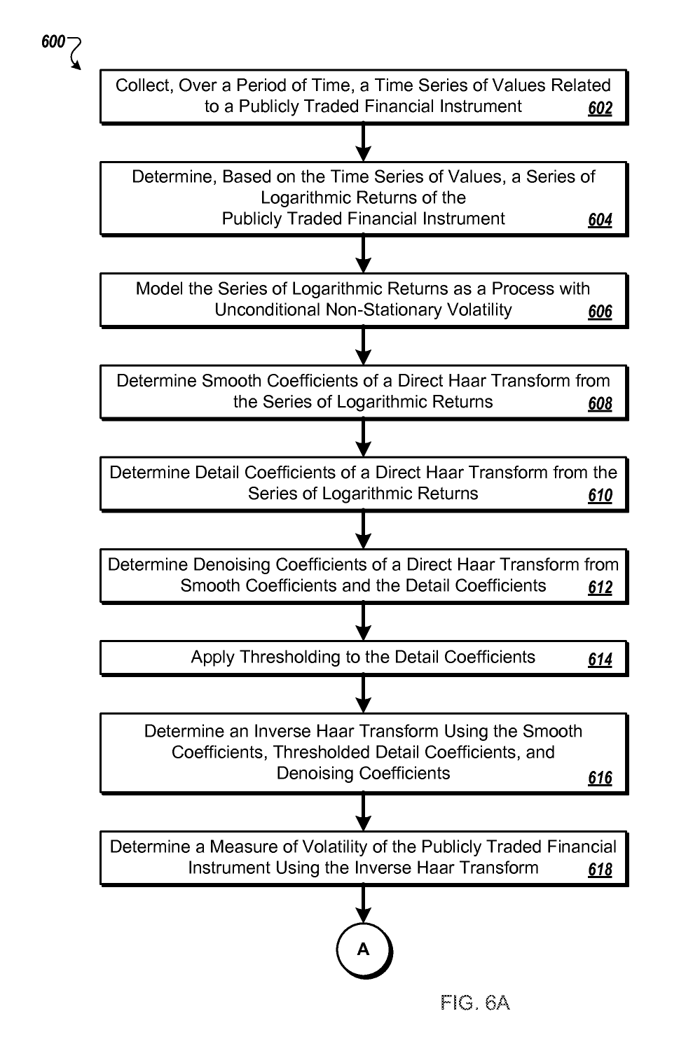

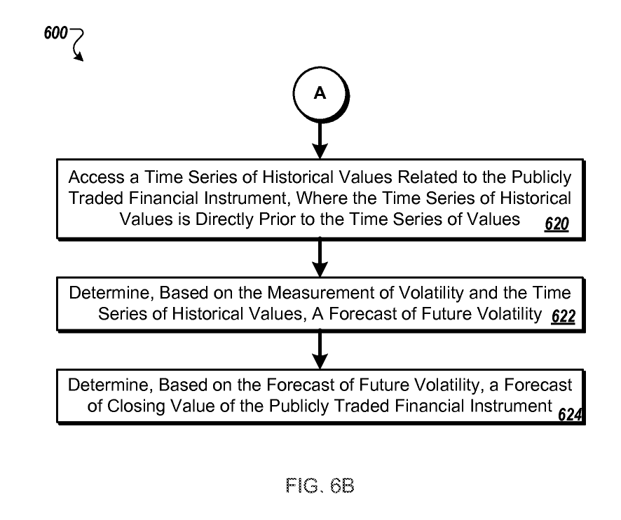

FIGS. 6A and 6B illustrate a flow chart of an example method for estimating volatility and future closing price of a financial index. The method 600, for example, may be performed by the processor of a computing device such as overlay computer system 104, herein referred to as processor 104, described in relation to FIG. 1.

In some embodiments, a time series of values related to a financial index market data is collected (602). For example, the lowest price of a financial index on a given day, the highest price of a financial index on a given day, the closing price of a financial index on a given day are collected over a period of multiple days from a financial source such as financial market computer system 102 of FIG. 1 in database 112. From such data, an exponential moving average of the time series TRₜ is calculated.

In some embodiments, a series of logarithmic returns of the financial index is determined based on the collected time series of values of the financial index (604). For example, logarithmic returns (rₜ^{TR}) of the financial investment's average true range time series is calculated.

In some embodiments, the time series of logarithmic returns is modeled as a process with unconditional non-stationary volatility (606). For example, a series of logarithmic returns can be modeled as a bounded piece wise deterministic function with unconditional non-stationary volatility using squared log-returns of the values of the time series of measured financial investment prices (rₜ^{TR})².

In some embodiments, smooth coefficients of a direct Haar transform are determined from the series of logarithmic returns (608). For example, smoothing coefficients are determined to smooth the true range logarithmic returns by using the unconditional non-stationary volatility model of the logarithmic returns series of the price of the financial index.

In some embodiments, detail coefficients of a direct Haar transform are determined from the series of logarithmic returns (610). For example, detail coefficients are determined to smooth the true range logarithmic returns by using the unconditional non-stationary volatility model of the logarithmic returns series of the prices of the financial index. The detail coefficients may further be thresholded to allow for a more noise free calculation of the volatility estimate.

In some embodiments, denoising coefficients of a direct Haar transform are determined from the smooth and detail coefficients (612). For example, denoising coefficients are calculated to determine the volatility estimate by using detail coefficients and smooth coefficients stored as Haar transform coefficients.

In some embodiments, an investment strategy computing device applies thresholding to the detail coefficients (614). Either hard or soft thresholding may be applied using a thresholding policy to remove noise from the measured financial index price data.

In some embodiments, an inverse Haar transform is determined using the smooth coefficients, thresholded detail coefficients, and denoising coefficients (616). The inverse Haar transform used to calculate the volatility function using the measured financial index prices. A measure of volatility of the publicly traded financial index is calculated using the inverse Haar transform (618).

In some embodiments, the investment strategy computing device accesses a time series of historical values related to the publicly traded financial index (620). The time series of historical values is directly prior to the measured time series value stored as financial index price data. Accessing such historical values creates a large set of data points from which to conduct volatility forecasts. Upon creating such a repository of historic time series values, a forecast of future volatility can be determined based on the volatility measurement and the historical time series data (622).

In some embodiments, a forecast of the closing value of a financial index is determined (624) based on the forecast of the future volatility calculated in step 622. Such a value may be used to determine whether to retain or remove the financial index from a financial portfolio.

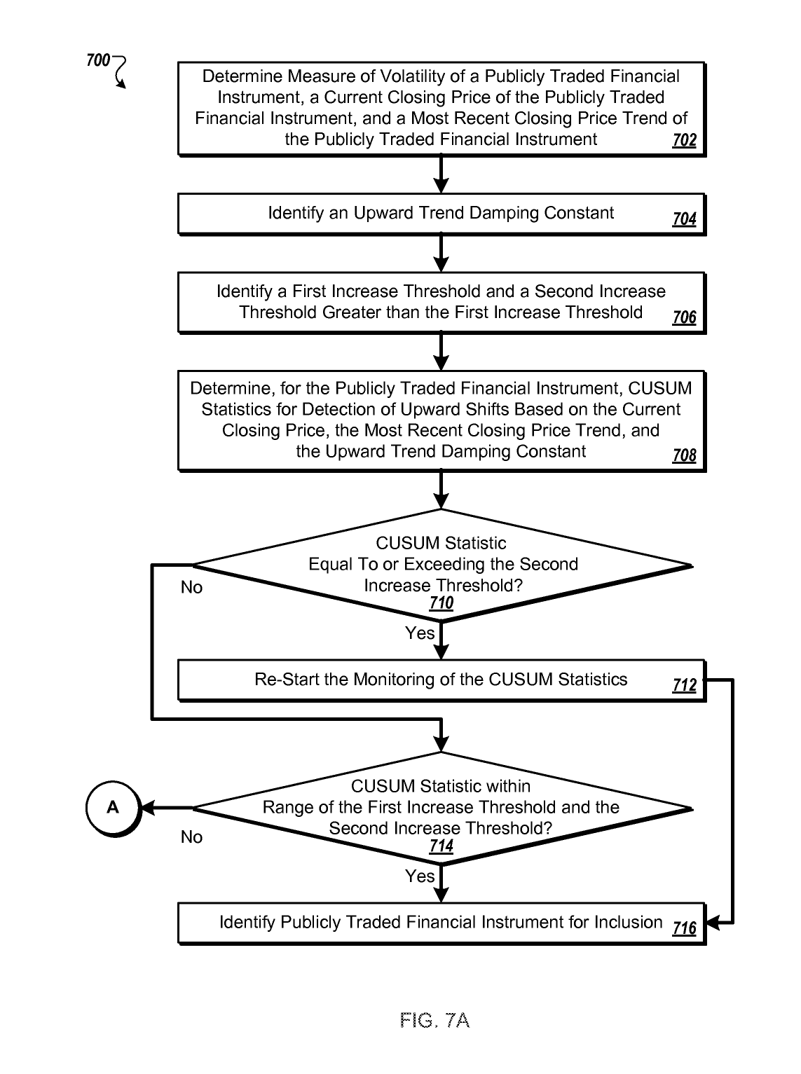

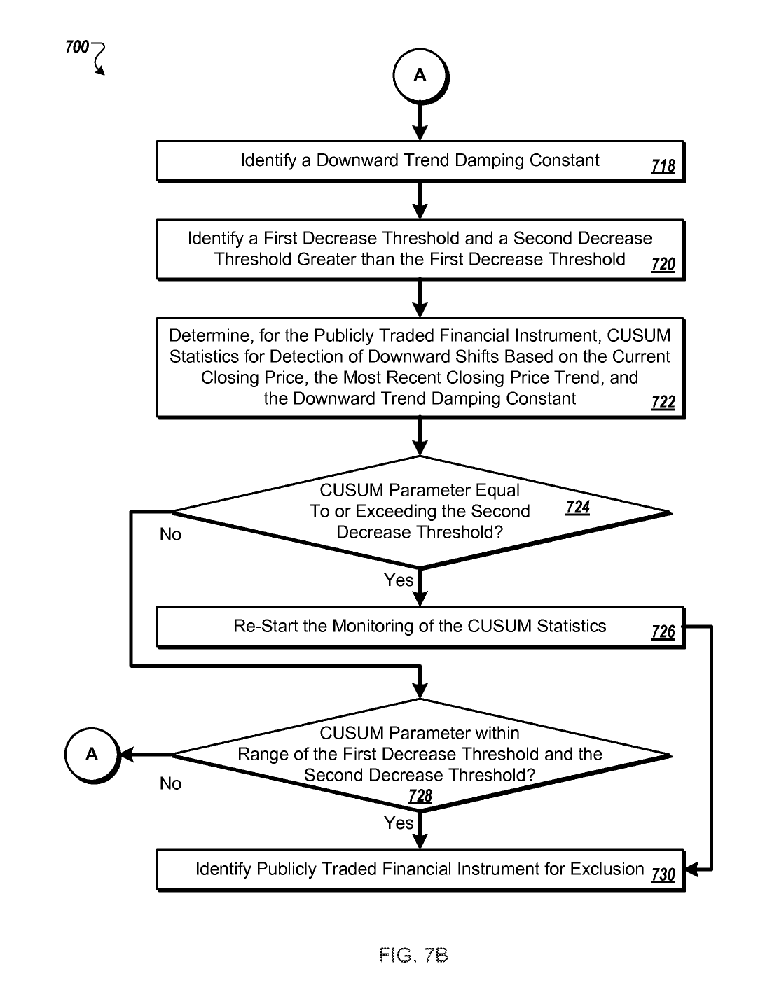

FIGS. 7A and 7B illustrate a flow chart of an example method for applying CUSUM statistics to detect shifts in the price of a financial index. The method 700, for example, may be performed by the processor of a computing device such as overlay computer system 104, herein referred to as processor 104, described in relation to FIG. 1.

In some embodiments, volatility measure, current closing price, and most recent closing price trend of a financial index are determined (702) as illustrated in the steps outlined in the flow charts of FIGS. 6A and 6B and as described in relation to FIG. 1. For example volatility data, current closing price, and closing price trend are determined for a financial index.

In some embodiments, an upward trend damping constant is identified (704). The upward trend damping constant γ⁺ is identified, often by tuning from different values of damping constant within an interval. The damping constant is used in a CUSUM algorithm to determine whether the current closing price is significantly greater or significantly lesser than the closing price trend of a financial index.

In some embodiments, a first increase threshold and a second increase threshold greater in value than the first increase threshold are identified (706). For instance, the increase thresholds h₂⁺ and h₁⁺ are tuned by investment decision module 210 of FIG. 2 using multiple values uniformly spaced apart in an interval.

In some embodiments, CUSUM statistics for detection of upward shifts in the current closing price of the financial index are determined (708) using the current closing price, most recent closing price trend, and the upward damping constant.

In some embodiments, the CUSUM statistic is compared against the second increase threshold to determine whether the CUSUM statistic is equal to or exceeds the second increase threshold (710). If the CUSUM statistic exceeds or equals the second increase threshold, method 700 proceeds to restart monitoring of the CUSUM statistic (712) and identifies the financial index for inclusion into the owner's financial portfolio (716). If the CUSUM statistic does not exceed or equal the second increase threshold, method 700 proceeds to determine whether the CUSUM statistic is within range of the first increase threshold and second increase threshold (714). If the CUSUM statistic is within range of the first increase threshold and second increase threshold, the financial index is identified for inclusion in the owner's financial portfolio (716). However, if the CUSUM statistic is not within range of the first increase threshold and second increase threshold, then the method proceeds to identify a downward trend damping constant (718). The downward trend damping constant γ⁻ is identified, often by tuning from different values of damping constant within an interval.

In some embodiments, a first decrease threshold and a second decrease threshold greater in value than the first increase threshold are identified (720). For instance, the increase thresholds h₂⁻ and h₁⁻ are tuned using multiple values uniformly spaced apart in an interval.

In some embodiments, CUSUM statistics for detection of downward shifts in the current closing price of the financial index is determined (722) using the current closing price, most recent closing price trend, and the downward damping constant.

In some embodiments, the CUSUM statistic is compared against the second decrease threshold to determine whether the CUSUM statistic is equal to or exceeds the second decrease threshold (724). If the CUSUM statistic exceeds or equals the second decrease threshold, method 700 proceeds to restart monitoring of the CUSUM statistic (726) and identifies the financial index for exclusion from the owner's financial portfolio (730). If the CUSUM statistic does not exceed or equal the second decrease threshold, method 700 proceeds to determine whether the CUSUM statistic is within range of the first decrease threshold and second decrease threshold (728). If the CUSUM statistic is within range of the first decrease threshold and second decrease threshold, the financial index is identified for exclusion in the owner's financial portfolio (730). However, if the CUSUM statistic is not within range of the first increase threshold and second increase threshold, then the method proceeds to identify a downward trend damping constant at step 718.

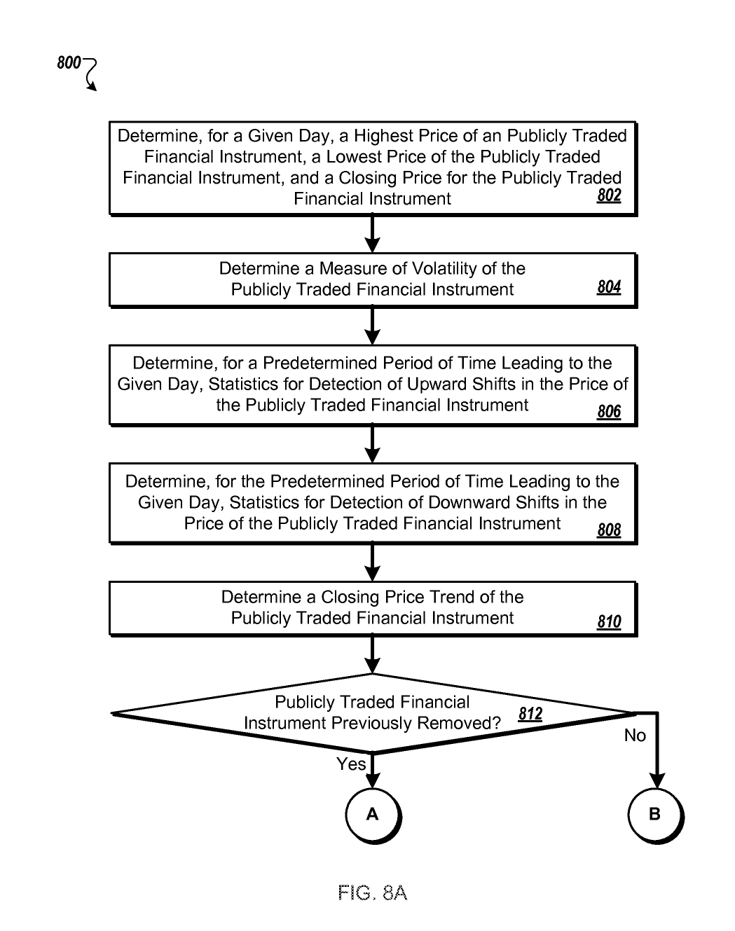

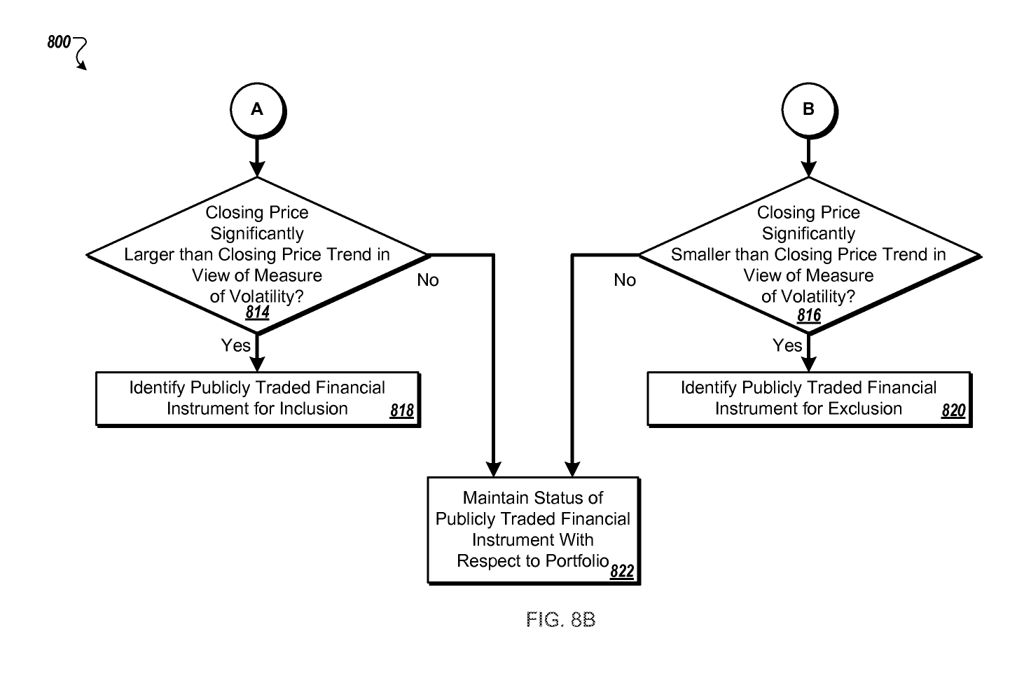

FIGS. 8A and 8B illustrate a flow chart of an example method for making decisions regarding investment portfolio adjustments based upon volatility measurements and statistics on price shifts. The method 800, for example, may be performed by the processor of a computing device such as the computer overlay system 104 in FIG. 1.

In some embodiments, the highest price, lowest price, and the closing price, for a given day, of a financial index are determined (802). For instance, processor 104 obtains such market data for the current day and may store such data as financial index price data.

In some embodiments, the measure of volatility of the financial index is determined (804). For example, processor 104 may determine a measure of volatility of the financial index using an inverse Haar transform of Haar coefficient values calculated from a logarithmic return values of the financial index as shown in steps 604, 606, 608, 610, 612, 614, 616, and 618 of FIG. 6A.

In some embodiments, statistics for detection of upward shifts in the price of the financial index for a predetermined period of time leading up to the given day are determined (806). For instance, a CUSUM upward statistic gₜ⁺ is determined for a predetermined time period until the current day is determined.

In some embodiments, statistics for detection of downward shifts in the price of the financial index for a predetermined period of time leading up to the given day are determined (808). For instance, a CUSUM upward statistic gₜ⁻ is determined for a predetermined time period until the current day is determined.

In some embodiments, a closing price trend of the financial index is determined (810). The closing price trend may be determined based upon a future volatility forecast of the financial index prices as described in step 624 of FIG. 6B. The closing price trend may be used to determine whether to retain or remove the financial index from a financial portfolio.

In some embodiments, a determination is made whether the financial index was previously removed from the financial portfolio (812). For example, processor 104 collects historic output data of the investment strategy computing device from market data 128, previous decision outputs to determine if the financial index was removed from the financial portfolio of the owner, in particular during the previous time period.

If the financial index is determined to have been previously removed from the financial portfolio, the method proceeds to determine whether the closing price is significantly larger than the closing price trend in view of the volatility measure (814). For example, a computing device determines whether the current closing price for the given day is significantly larger (i.e., larger than the measured volatility) than the closing price trend. If the closing price is significantly greater than the closing price trend in view of the measured volatility, the financial index is included in the financial portfolio of the owner (818). However, if the closing price is not significantly greater than the closing price trend in view of the measured volatility, then the status of the financial index is maintained with respect to the portfolio (822). For example, the investment decision from the previous time period is maintained for the subsequent time period with respect to the financial index.

If the financial index is not determined to have been previously removed from the financial portfolio at step 812, the method proceeds to determine whether the closing price is significantly smaller than the closing price trend in view of the volatility measure (816). For example, a computing device determines whether the current closing price for the given day is significantly smaller (i.e., smaller than the measured volatility) than the closing price trend. If the closing price is significantly smaller than the closing price trend in view of the measured volatility, the financial index is identified for exclusion from the financial portfolio of the owner (820). However, if the closing price is not significantly smaller than the closing price trend in view of the measured volatility, then the status of the financial index is maintained with respect to the portfolio (822).

Although described in relation to a particular series of steps, in some implementations, methods 300, 400, 500, 600, 700, and 800 may include more or fewer steps. In some implementations, one or more of the steps of the method methods 300, 400, 500, 600, 700, and 800 may be arranged in a different order. Other modifications of the methods 300, 400, 500, 600, 700, and 800 are possible without deviating from the concepts and scope of these methods.

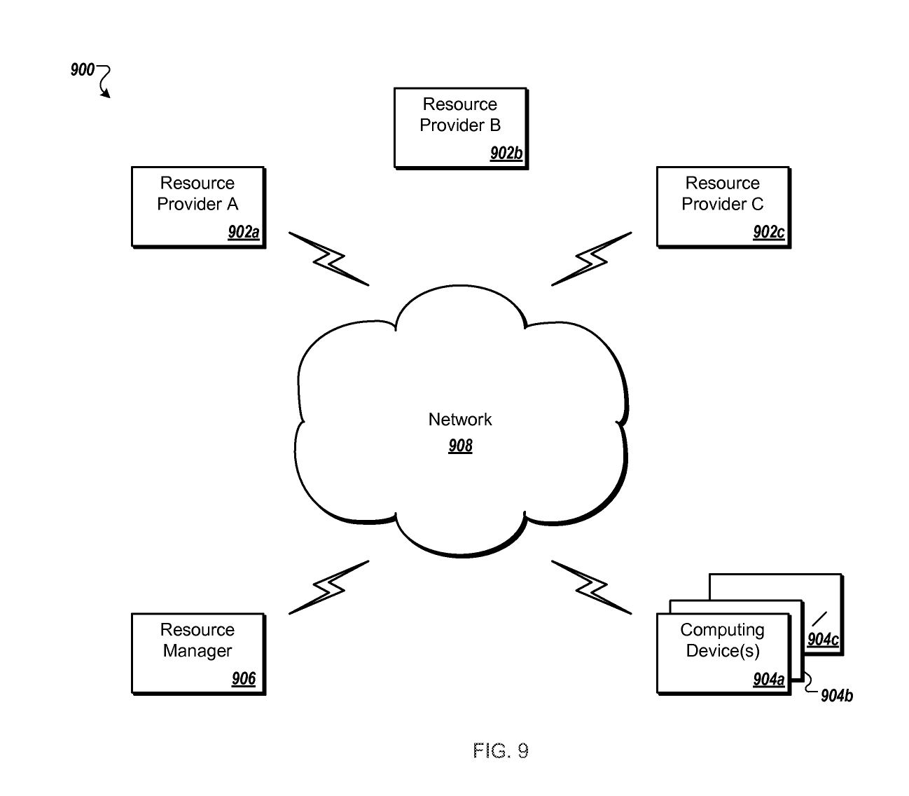

As shown in FIG. 9, an implementation of a network environment 900 for use in determining the sustainability of a portfolio to support retirement income needs is shown and described. In brief overview, referring now to FIG. 8, a block diagram of an exemplary cloud computing environment 900 is shown and described. The cloud computing environment 900 may include one or more resource providers 902a, 902b, 902c (collectively, 902). Each resource provider 902 may include computing resources. In some embodiments, computing resources may include any hardware and/or software used to process data. For example, computing resources may include hardware and/or software capable of executing algorithms, computer programs, and/or computer applications. In some embodiments, exemplary computing resources may include application servers and/or databases with storage and retrieval capabilities. Each resource provider 902 may be connected to any other resource provider 902 in the cloud computing environment 900. In some embodiments, the resource providers 902 may be connected over a computer network 908. Each resource provider 902 may be connected to one or more computing device 904a, 904b, 904c (collectively, 904), over the computer network 908.

The cloud computing environment 900 may include a resource manager 906. The resource manager 906 may be connected to the resource providers 902 and the computing devices 904 over the computer network 908. In some embodiments, the resource manager 906 may facilitate the provision of computing resources by one or more resource providers 902 to one or more computing devices 904. The resource manager 906 may receive a request for a computing resource from a particular computing device 904. The resource manager 906 may identify one or more resource providers 902 capable of providing the computing resource requested by the computing device 904. The resource manager 906 may select a resource provider 902 to provide the computing resource. The resource manager 906 may facilitate a connection between the resource provider 902 and a particular computing device 904. In some embodiments, the resource manager 906 may establish a connection between a particular resource provider 902 and a particular computing device 904. In some embodiments, the resource manager 906 may redirect a particular computing device 904 to a particular resource provider 902 with the requested computing resource.

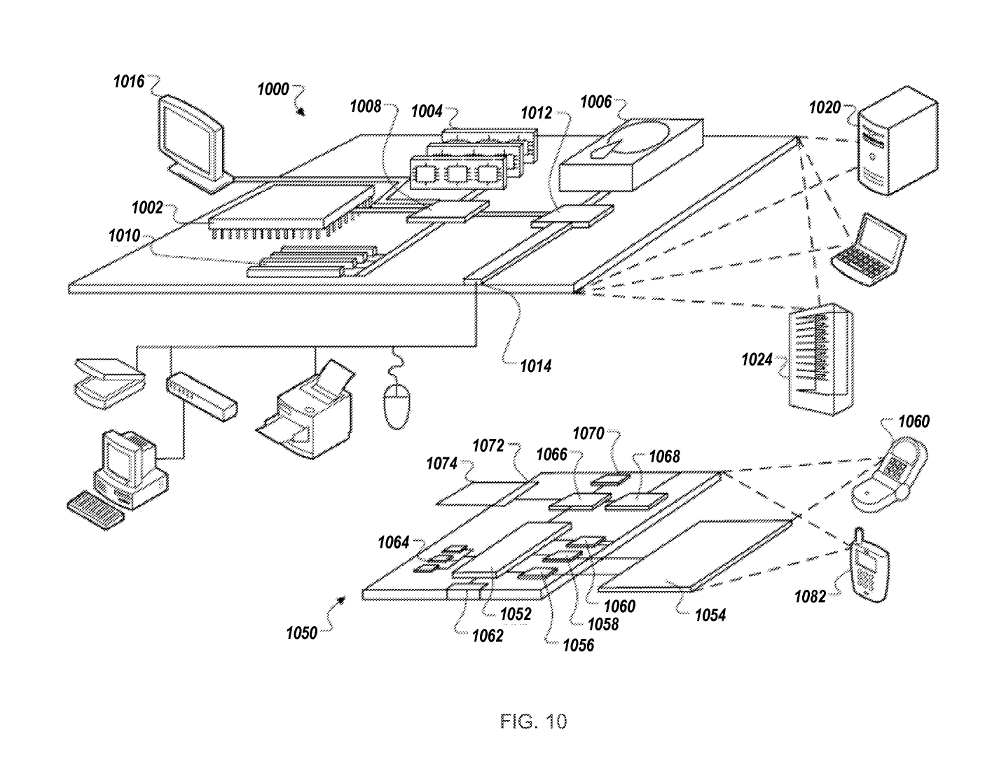

FIG. 10 shows an example of a computing device 1000 and a mobile computing device 1050 that can be used to implement the techniques described in this disclosure. The computing device 1000 is intended to represent various forms of digital computers, such as laptops, desktops, workstations, personal digital assistants, servers, blade servers, mainframes, and other appropriate computers. The mobile computing device 1050 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 1006, the high-speed interface 1008, the high-speed expansion ports 1010, and the low-speed interface 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other embodiments, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1004 stores information within the computing device 1000. In some embodiments, the memory 1004 is a volatile memory unit or units. In some embodiments, the memory 1004 is a non-volatile memory unit or units. The memory 1004 may also be another form of computer-readable medium, such as a magnetic or optical disk.

The storage device 1006 is capable of providing mass storage for the computing device 1000. In some embodiments, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1002), perform one or more methods, such as those described above. The instructions can also be stored by one or more storage devices such as computer- or machine-readable mediums (for example, the memory 1004, the storage device 1006, or memory on the processor 1002).

The high-speed interface 1008 manages bandwidth-intensive operations for the computing device 1000, while the low-speed interface 1012 manages lower bandwidth-intensive operations. Such allocation of functions is an example only. In some embodiments, the high-speed interface 1008 is coupled to the memory 1004, the display 1016 (e.g., through a graphics processor or accelerator), and to the high-speed expansion ports 1010, which may accept various expansion cards (not shown). In the implementation, the low-speed interface 1012 is coupled to the storage device 1006 and the low-speed expansion port 1014. The low-speed expansion port 1014, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. In addition, it may be implemented in a personal computer such as a laptop computer 1022. It may also be implemented as part of a rack server system 1024. Alternatively, components from the computing device 1000 may be combined with other components in a mobile device (not shown), such as a mobile computing device 1050. Each of such devices may contain one or more of the computing device 1000 and the mobile computing device 1050, and an entire system may be made up of multiple computing devices communicating with each other.

The mobile computing device 1050 includes a processor 1052, a memory 1064, an input/output device such as a display 1054, a communication interface 1066, and a transceiver 1068, among other components. The mobile computing device 1050 may also be provided with a storage device, such as a micro-drive or other device, to provide additional storage. Each of the processor 1052, the memory 1064, the display 1054, the communication interface 1066, and the transceiver 1068, are interconnected using various buses, and several of the components may be mounted on a common motherboard or in other manners as appropriate.

The processor 1052 can execute instructions within the mobile computing device 1050, including instructions stored in the memory 1064. The processor 1052 may be implemented as a chipset of chips that include separate and multiple analog and digital processors. The processor 1052 may provide, for example, for coordination of the other components of the mobile computing device 1050, such as control of user interfaces, applications run by the mobile computing device 1050, and wireless communication by the mobile computing device 1050.

The processor 1052 may communicate with a user through a control interface 1058 and a display interface 1056 coupled to the display 1054. The display 1054 may be, for example, a TFT (Thin-Film-Transistor Liquid Crystal Display) display or an OLED (Organic Light Emitting Diode) display, or other appropriate display technology. The display interface 1056 may include appropriate circuitry for driving the display 1054 to present graphical and other information to a user. The control interface 1058 may receive commands from a user and convert them for submission to the processor 1052. In addition, an external interface 1062 may provide communication with the processor 1052, so as to enable near area communication of the mobile computing device 1050 with other devices. The external interface 1062 may provide, for example, for wired communication in some embodiments, or for wireless communication in other embodiments, and multiple interfaces may also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 may also be provided and connected to the mobile computing device 1050 through an expansion interface 1072, which may include, for example, a SIMM (Single In Line Memory Module) card interface. The expansion memory 1074 may provide extra storage space for the mobile computing device 1050, or may also store applications or other information for the mobile computing device 1050. Specifically, the expansion memory 1074 may include instructions to carry out or supplement the processes described above, and may include secure information also. Thus, for example, the expansion memory 1074 may be provide as a security module for the mobile computing device 1050, and may be programmed with instructions that permit secure use of the mobile computing device 1050. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some embodiments, instructions are stored in an information carrier. that the instructions, when executed by one or more processing devices (for example, processor 1052), perform one or more methods, such as those described above. The instructions can also be stored by one or more storage devices, such as one or more computer- or machine-readable mediums (for example, the memory 1064, the expansion memory 1074, or memory on the processor 1052). In some embodiments, the instructions can be received in a propagated signal, for example, over the transceiver 1068 or the external interface 1062.

The mobile computing device 1050 may communicate wirelessly through the communication interface 1066, which may include digital signal processing circuitry where necessary. The communication interface 1066 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1068 using a radio-frequency. In addition, short-range communication may occur, such as using a Bluetooth®, Wi-Fi™, or other such transceiver (not shown). In addition, a GPS (Global Positioning System) receiver module 1070 may provide additional navigation- and location-related wireless data to the mobile computing device 1050, which may be used as appropriate by applications running on the mobile computing device 1050.

The mobile computing device 1050 may also communicate audibly using an audio codec 1060, which may receive spoken information from a user and convert it to usable digital information. The audio codec 1060 may likewise generate audible sound for a user, such as through a speaker, e.g., in a handset of the mobile computing device 1050. Such sound may include sound from voice telephone calls, may include recorded sound (e.g., voice messages, music files, etc.) and may also include sound generated by applications operating on the mobile computing device 1050.

The mobile computing device 1050 may be implemented in a number of different forms, as shown in the figure. For example, it may be implemented as a cellular telephone 1080. It may also be implemented as part of a smart-phone 1082, personal digital assistant, or other similar mobile device.

Various embodiments of the systems and techniques described here can be realized in digital electronic circuitry, integrated circuitry, specially designed ASICs (application specific integrated circuits), computer hardware, firmware, software, and/or combinations thereof. These various embodiments can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some embodiments, a system and method for determining and providing a financial overlay for investment portfolio adjustment to mitigate financial risk are provided. Having described certain embodiments of methods and apparatus for supporting financial overlay determination and application, it will now become apparent to one of skill in the art that other embodiments incorporating the concepts of the disclosure may be used. Therefore, the disclosure should not be limited to certain embodiments, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

1. A system for determining a trading strategy that makes intelligent decisions on whether to retain or remove a financial index from a market portfolio, the system comprising a processor and a memory storing a set of instructions that, when executed by the processor, cause the processor to:
measure the current closing price of a financial index for a plurality of days;
calculate a closing price trend of the financial index by using the current closing price of the plurality of days;
calculate a true range market volatility measure for each day of the plurality of days;
suppress undesired noise in the market volatility measure by computing a HAAR based average of the true range market volatility measure of the plurality of days;
calculate a CUSUM statistic by performing a cumulative sum based algorithm for disorder detection using the noise suppressed market volatility measure, current closing price of the financial index for a particular day, and the calculated closing price trend; and
determine whether the current closing price for the particular day is bigger than or smaller the closing price trend by applying the CUSUM statistic, whereupon one of (i) or (ii) is performed:
(i) upon determining that the current closing price is bigger than the closing price trend, retain the financial index in the market portfolio; and
(ii) upon determining that the current closing price is smaller than the closing price trend, maintain the CUSUM statistic for subsequent CUSUM calculations and remove the financial index from the market portfolio in the future.

2. The system of claim 1, wherein the instructions cause the processor to calculate the true range market volatility by:
calculating smooth coefficients and detail coefficients of a direct HAAR transform from the current closing price of the financial index for the plurality of days;
determining HAAR coefficients from the smooth coefficients and the detail coefficients;
performing hard or soft thresholding of the detail coefficients using the HAAR coefficients; and
calculating an inverse HAAR transform from the smooth coefficients and the thresholded detail coefficients.

3. The system of claim 1, wherein the instructions cause the processor to:
upon determining that the current closing price is bigger than the closing price trend, restart computation of the CUSUM statistic; and set the CUSUM statistic to zero.

4. The system of claim 1, wherein the instructions cause the processor to:
iteratively update the true range market volatility measure; and
iteratively update the CUSUM statistic using current market data.

5. The system of claim 1, wherein the instructions cause the processor to determine whether the current closing price for the particular day is significantly bigger or significantly smaller than the closing price trend by performing one or both of the following:
(i) determining whether the current closing price for the particular day is significantly higher than the closing price trend by comparing the CUSUM statistic against a predetermined maximum threshold stored in the memory; and
(ii) determining whether the current closing price for the particular day is significantly lower than the closing price trend by comparing the CUSUM statistic against a predetermined minimum threshold stored in the memory.

6. The system of claim 1, wherein the CUSUM statistic is calculated to reduce risk of severe loss to the market portfolio in volatile market conditions.

7-12. (canceled)

13. A method comprising:
receiving, via a network, by a first entity, financial data regarding a plurality of investments;
identifying, by a processor of a computing device, a respective market sector associated with each investment of the plurality of investments;
analyzing, by the processor, for each market sector of a plurality of market sectors, one or more investments of the plurality of investments to determine a status of the respective market sector, wherein
each investment of the one or more investments is associated with the respective market sector, and
the status is based at least in part on one or more of a) a change in behavior, and b) a correlation to a financial index;
determining, by the processor, based in part upon the status, a decision associated with a first market sector of the plurality of market sectors; and
providing, to a second entity, the decision for use as a financial overlay to a financial portfolio, wherein the financial portfolio comprises the first market sector.

14. The method of claim 13, wherein a first financial portfolio comprises the plurality of market sectors, and the financial portfolio comprises at least a portion of the plurality of market sectors.

15. The method of claim 14, wherein the decision concerns whether to increase at least one of a cash position and a cash equivalent position with respect to the first financial portfolio.

16. The method of claim 14, wherein determining the decision further comprises: customizing the first financial portfolio based at least in part on one or more of a) information pertaining to the financial portfolio, and b) preferences provided by the second entity.

17. The method of claim 16, wherein the preferences provided by the second entity comprise at least one of:
a) a maximum limit of a proportion of the financial portfolio in at least one of cash and cash equivalent financial instruments;
b) an identification of one or more market sectors of interest;
c) an identification of one or more market sectors to exclude from the financial portfolio;
d) one or more regulatory constraints associated with the financial portfolio;
e) contractual constraints associated with the financial portfolio; and
f) investment guidelines associated with the financial portfolio.

18. The method of claim 14, wherein determining the decision further comprises determining the decision based at least in part on activity of the plurality of market sectors of the first financial portfolio.

19. The method of claim 14, wherein determining the decision further comprises at least one of:
removing market sectors from the plurality of market sectors of the first financial portfolio; and
adding one or more additional market sectors to the plurality of market sectors of the first financial portfolio.

20. The method of claim 14, wherein the decision comprises information regarding at least one of:
(a) one or more market sectors included in the first financial portfolio;
(b) one or more market sectors excluded from the first financial portfolio;
(c) one or more market sectors added to the first financial portfolio;
(d) one or more market sectors removed from the first financial portfolio;
(e) one or more market sectors anticipated to perform negatively; and
(f) one or more market sectors anticipated to perform positively.

21. The method of claim 13, further comprising:
providing updated determinations of the decision as part of a subscription service provided by the first entity; and
receiving compensation from the second entity in return for the subscription service.

22. The method of claim 13, wherein the plurality of market sectors comprise one or more sectors of the U.S. economy equity markets.

23. The method of claim 13, wherein the plurality of market sectors comprise one or more indexed equity categories associated with the Standard & Poor 500 index.

24. The method of claim 13, wherein the plurality of market sectors comprise: one or more sectors of fixed income markets.

25. The method of claim 13, wherein the decision is updated at least one of: periodically, aperiodically, at a frequency, and at discrete time periods.

26. The method of claim 13, wherein the decision comprises at least one of:
(a) a percentage of the financial portfolio to be in at least one of cash and cash equivalent financial instruments;
(b) a proportion of the financial portfolio to be in at least one of cash and cash equivalent financial instruments; and
(c) an amount of the financial portfolio to be in at least one of cash and cash equivalent financial instruments.

27-69. (canceled)
